(19) United States
(12) Patent Application Publication
(10) Pub. No.: US 2012/0107614 A1
(43) Pub. Date: May 3, 2012

(54) METHOD OF COATING A SUBSTRATE SURFACE, AND COATED SUBSTRATES PREPARED THEREBY

(76) Inventors: Yigal Dov Blum, San Jose, CA (US); David Brent MacQueen, Foster City, CA (US); David K. Hui, San Francisco, CA (US); Songqi Liu, Fremont, CA (US)

(21) Appl. No.: 12/916,307

(22) Filed: Oct. 29, 2010

(51) Int. Cl. B05D 5/00; B32B 9/04; B05D 3/10; B05D 3/02; B05D 3/00

(52) U.S. Cl. 428/411.1; 427/333; 427/299

(57) ABSTRACT

The invention provides compositions and methods useful in providing strongly bonded functional layers on substrates. In some embodiments, the invention provides functionalized substrate surfaces that have a surface property selected from smudge resistance, easy clean, oleophobic, oleophilic, hydrophobic, hydrophilic, electrostatic, sorbing, electroresponsive, charge responsive, bioinert, and bioactive. Methods for the manufacture of such coated substrates are provided. The invention finds utility, for example, in the fields of surface and ultrathin coating chemistry and chemical functionalization of surfaces. In some embodiments, the method provides surfaces having smudge resistance and easy-clean characteristics.

### TECHNICAL FIELD

This disclosure relates generally to compositions and methods useful in providing coatings on substrates. The invention finds utility, for example, in the fields of surface and coating chemistry.

### BACKGROUND

Coating chemistry continues to play an important role in a wide variety of applications such as electronic displays. Coatings that impart specific advantageous properties to a surface are particularly desirable. One of the earliest examples in display technology is the phosphorescence layer that forms a coating on a glass substrate inside of cathode ray tubes.

A variety of coatings and methods for preparing coatings on substrates have been investigated. Such methods may be conveniently grouped into methods that produce coatings that are physically adsorbed to the underlying substrate, and methods that produce coatings that are chemically bonded to the underlying substrate. In an example of the former, a coating material can be solution deposited or spray coated onto a substrate. Evaporation of the solvent leaves the coating material physically adsorbed on the substrate. In an example of the latter, a coating material having a reactive group is exposed to a substrate. Reaction of the reactive group with the surface creates a coating layer that is chemically bonded to the surface.

Coatings have been found useful in a variety of applications, for example in modifying the surface properties of the underlying substrate. From anti-reflective coatings on sunglasses to non-stick coatings on cookware, coatings can be both commercially important and functional.

For example, U.S. Pat. No. 3,867,175 discloses a non-fogging, abrasion resistant material provided by applying a transparent, non-fogging coating to a normally fogging, transparent or reflecting substrate. The non-fogging, abrasion resistant coating comprises a highly cross-linked alkylene imine polymer. The polyalkylene imine may be further modified by an adhesion promoter through reaction with the amine hydrogens of the polyimine.

U.S. Pat. No. 6,355,751 describes a curable coating with improved adhesion to glass. A composition is described that is useful for making a coated optical fiber and comprises a photocurable or E-beam curable composition having an alkoxysilane functionality attached through a long backbone.

U.S. Pat. No. 6,413,588 describes a method for producing durable layered coatings. The process includes subjecting the surface of a difficult-to-coat substrate to an adhesion promoting step, followed by applying an intermediate layer of flexible primer, which contains a polyester copolymer produced through a two-stage polymerization process. A mar resistant top layer of clear coating composition is then applied over the intermediate layer to produce the multi-layered durable coating on the difficult-to-coat substrate.

U.S. Pat. No. 6,680,080 describes a method for preparing an antiglare coating. The method comprises a step of deposition a layer of a fluorinated polymer with a low refractive index onto the substrate from a deposition solution that includes said fluorinated polymer. The method

U.S. Pat. No. 7,101,616 discloses a smudge resistant nanocomposite hardcoat. Latent reactive nanoparticles are contained within a binder phase to form a nanocomposite. When deprotected and treated with a reactive fluorochemical, nanoparticles present at the surface of the nanocomposite become permanently modified and impart smudge resistance. The method produces relatively thick coatings—from about 0.5 microns to about 10 microns—that are not complete transparent, if such coatings are transparent at all.

There remains a need in the art for the development of thin transparent coatings with tailorable surface characteristics, strong bonding to the coated substrate, complete transparency, and long-term durability under normal or severe mechanical and chemical performance conditions, and such coatings would be suitable for a variety of applications. For example, when foreign substances such as grease or dirt are deposited at the surface of electronic displays, the displays can suffer from reduced transparency and impaired visibility. Smudges from human fingerprints are a particularly common source of grease that can be unsightly or reduce the performance of electronic displays. For most current electronic displays, removing smudges and foreign substances in general requires specialized cloths and/or cleaning solutions to effectively remove the smudge while avoiding scratching or otherwise damaging the display and any coatings thereon.

In some aspects, opposite characteristics to the above example are required for applications where strong affinity and improved wetting of liquids such as water, oils and organic solvents is desired. Examples for articles that need such advanced wetting characteristics are microchannels, microfilters, and microinjectors. Other examples are surfaces sliding in fluids or against other surfaces, in which improvement of the surface lubricity and tribological characteristics will enhance the device performance.

The present invention is directed at addressing one or more of the above mentioned drawbacks, as well as similar issues pertaining to surface coatings. The present invention is directed to coatings using a variety of materials and which may be provided on a wide variety of substrates.

### SUMMARY OF THE INVENTION

The present disclosure describes compositions and methods for the preparation of surface coatings having a wide range of properties.

In one aspect, there is provided herein a method for forming robustly bonded layers on a substrate.

In some embodiments, the methods of the invention comprise a first step of forming a first layer of a coupling compound on a surface of the substrate by contacting and chemically bonding the coupling compound to surface exposed reactive groups on the substrate. The coupling compound has at least one of a first reactive group (also referred to as a “first type of reactive group”) that is capable of chemically bonding with the surface exposed reactive groups and at least one of a second reactive group (also referred to as a “second type of reactive group”). The second reactive group may be the same as the first reactive group, or may be different from the first reactive group. The second reactive group may be relatively unreactive with the surface exposed reactive groups, compared with the reactivity of the first reactive group. The coupling compound may further contain additional reactive groups (one or more of which may be identical to the first reactive group and one or more of which may be identical to the second reactive group). The methods further comprise a second step of forming a functional coating layer by reacting the second reactive group of the coupling compound with a functional layer compound comprising at least one reactive group capable of chemically bonding with the second reactive group of the coupling compound. By the second reactive group of the coupling compound being “unreactive” is meant that such groups are either unable to reactive with the surface exposed reactive groups, or the reaction between such groups is substantially slower compared with the reaction of the first reactive group of the coupling compound with the surface exposed reactive groups.

In some embodiments, the invention provides the aforementioned methods, wherein the first reactive group or type of reactive group of the coupling compound is capable of forming a covalent bond with the surface exposed reactive groups, and wherein the second reactive group or type of reactive group of the coupling compound is unreactive toward forming a covalent bond with the surface exposed reactive groups.

In some embodiments, the invention provides the aforementioned methods, wherein the second reactive group or type of reactive group of the coupling compound is capable of forming a covalent bond with the reactive group of the functional layer compound, and wherein the second step is carried out in the presence or absence of a catalyst.

In some embodiments, the invention provides the aforementioned methods, wherein prior to the first step the substrate is precoated or pretreated to activate the surface of the substrate for reacting with the coupling compound. For example, the substrate may be an organic substrate (e.g., polymeric, etc.), and the pretreatment may comprise corona discharge, radiation, heat, plasma oxidation, strong acid, chromate, permanganate, or combinations thereof. Also for example, the substrate may be an organic material coated with an inorganic film.

In some embodiments, the invention provides the aforementioned methods, wherein the reaction between the coupling compound and the surface exposed reactive groups occurs during or after immersion of the substrate in a solution containing the coupling compound.

In some embodiments, the invention provides the aforementioned methods, wherein the surface exposed reactive groups are selected from metal oxides, metal hydroxides, silicon-hydroxides, silicates, phosphates, phosphonates, sulfur oxides, amines, imines, carbonates, urethanes, anhydrides, oxiranes, olefins, vinyl compounds, esters, functionalized aromatics, hydroxyls, thiols, disulfides, carboxylic acids, hydrosilanes, and functionalized organosiloxanes.

In some embodiments, the invention provides the aforementioned methods, wherein the first reactive group or type of reactive group of the coupling compound is a protected or unprotected group selected from alkoxysilane, hydroxysilane, halosilane, hydrosilane, silazanyl, functionalized organosiloxane, phosphonate, phosphine, sulfur oxide, thiol, disulfide, sulphonate, amine, imine, amide, urethane, ureate, cyanurate, carboxylic acid, anhydride, ester, epoxy, carbonate, olefin, aromatic, functionalized aromatic, acetylacetonate, alcohol, and ether, and wherein when the first type of reactive group of the coupling compound is a protected group, the method further comprises deprotecting the first type of reactive group prior to or during the first step with a protecting group removal agent.

In some embodiments, the invention provides the aforementioned methods, wherein the second reactive group or type of reactive group of the coupling compound is a protected or unprotected group selected from amine, imine, carbonate, urethane, anhydride, epoxy, vinyl, acrylate, metacrylate, cyanate, isocyanate, thiocyanate, isothiocyanate, alcohol, aldehyde, thiols disulphide, carboxylic acid, hydrosilane, hydroxysilane, carboxysilane, enoxysilane, organosilane, alkoxysilane, aminosilane, thiosilane, epoxysilane, silanecarbylcarboxyl, vinylsilane, and alpha olefin silane, and wherein when the second reactive group or type of reactive group of the coupling compound is a protected group, the method further comprises deprotecting the second reactive group prior to or during the second step with a protecting group removal agent or with the functional layer compound.

In some embodiments, the invention provides the aforementioned methods, wherein the functional layer compound is selected from hydrocarbyl, halocarbyl, organosilane, and organosiloxane, any of which may contain one or more heteroatoms and may contain one or more substituents. For example, the functional layer compound is hydrocarbyl selected from alkyl, alkenyl, alkynyl, aryl, alkaryl, and aralkyl, or is halocarbyl selected from haloalkyl, haloalkenyl, haloalkynyl, haloaryl, haloalkaryl, and haloaralkyl. For example, the functional layer compound may comprise a chain having a length of at least 10 atoms or greater (such as 20 atoms or greater). For example, the functional layer compound may be a perfluorocarbon or a perfluoroether compound. For example, the functional layer compound may be a hydrocarbon, polyether, polycarboxylic acid, polyester, or polyamine chain.

In some embodiments, the invention provides the aforementioned methods, wherein at least one reactive group on the functional layer compound is selected from protected or unprotected amine, imine, carbonate, urethane, anhydride, epoxy, vinyl, acrylate, metacrylate, cyanate, isocyanate, thiocyanate, isothiocyanate, hydroxyl, aldehyde, thiol, disulphide, carboxylic acid, ester, halosilane, hydrosilane, hydroxysilane, carboxysilane, enoxysilane, glycidylsilane, alkoxysilane, vinylsilane and aminosilane.

In some embodiments, the invention provides the aforementioned methods, wherein the functional layer compound further comprises at least one functional group that is unreactive with the second type of reactive group of the coupling compound.

In some embodiments, the invention provides the aforementioned methods, wherein the functional group of the functional layer compound is selected from protected or unprotected amine, imine, halo, carbonate, urethane, anhydride, epoxy, oxime, vinyl, acrylate, metacrylate, cyanate, isocyanate, thiocyanate, isothiocyanate, hydroxyl, thiol, disulphide, carboxylic acid, hydrosilane, hydroxysilane, carboxysilane, enoxysilane, epoxysilane, alkoxysilane, vinylsilane and aminosilane, provided that the functional group is different from the reactive group of the functional layer compound. By “different” is meant that the reactivity of the functional group is different than the reactivity of the reactive group, and includes chemically different groups as well as protected versions of the same group. For example, the functional group comprises one or more groups selected from hydrocarbons, aromatic groups, fluorine, amine, carboxylic acid, alcohol, ester, ether, amide, thiol, silane, and siloxane.

In some embodiments, the invention provides a method for preparing a coated surface, the method comprising forming a chemical bond between a reactive group attached to a substrate and a first reactive group on a coupling compound such that the coupling compound is chemically bounded to the surface. The coupling compound further comprises a second reactive group. The method further comprises forming a chemical bond between the second reactive group on the coupling compound and a reactive group on a functional layer compound.

In some embodiments, the invention provides the aforementioned methods, wherein the substrate is pre-coated or pretreated prior to applying the coupling compound.

In some embodiments, the invention provides the aforementioned methods, wherein the functional layer compound provides a coating on the surface having a property selected from oleophobic, oleophilic, hydrophobic, hydrophilic, electrostatic, sorbing, electroresponsive, charge responsive, catalytic, bioinert, and bioactive.

In some embodiments, the invention provides the aforementioned methods, wherein the second reactive group of the coupling compound is non-reactive with the reactive group attached to the substrate.

In some embodiments, the invention provides the aforementioned methods, wherein the second reactive group of the coupling compound is a protected reactive group, and wherein the method further comprises contacting the protected reactive group with a protecting group removal agent.

In some embodiments, the invention provides the aforementioned methods, wherein the chemical reaction between (i) the reactive group on the substrate and the first reactive group on the coupling compound, or the chemical reaction between (ii) the second reactive group on the coupling compound and reactive group on the functional layer compound, or both chemical reactions (i) and (ii) occur by immersing the substrate in a solution (i.e., a solution of the coupling compound for reaction (i) and a solution of the functional layer compound for reaction (ii)).

In some embodiments, the invention provides the aforementioned methods further comprising an additional curing step that is carried out after the coupling compound is bonded to the substrate or after the functional layer compound is bonded to the coupling compound, or after both such steps.

In some embodiments, the invention provides the aforementioned methods, wherein one or both of the coupling compound and the functional layer compound is fluorinated.

In some embodiments, the invention provides a coating prepared using any of the aforementioned methods. Such coatings are, in some embodiments, “easy clean” coatings meaning that, relative to previously known coatings, the coatings of the invention require fewer and/or less frequent applications of a cleaning cloth or other cleaning implement. Furthermore, such coatings are, in some embodiments, “smudge resistant” which is defined in more detail herein.

In some embodiments, the methods comprise: (i) forming a first layer at a surface of the substrate by contacting the surface with a coupling compound having a first reactive group that is capable of forming a covalent bond with the surface and a second reactive group that is non-reactive with the surface; and (ii) forming a large molecules or macromolecular single layer by contacting the coupling compound with a functional layer compound comprising at least one reactive group capable of forming a covalent bond with the second reactive group of the coupling compound and the functional layer compound possesses a special performing characteristics. The layer can comprise macromolecules (e.g., oligomers, polymers, antibodies, proteins, and the like) or large molecules (e.g., molecules with a large molecular weight, such as greater than 100 D, or greater than 500 D, or greater than 1000 D, or greater than 1500 D). Loosely adhered large molecules or macromolecules are removed from the surface to maximize the robustness of the functionality obtained by the bonded film and to avoid leaching and contamination of the surrounding.

In another aspect, there is provided herein a method for preparing a functionally coated surface, the method comprising: forming a chemical bond between a reactive group of a substrate's surface and a first reactive group on a coupling compound (preferably but not necessarily a monolayer) such that the coupling compound is chemically bounded to the surface, wherein the coupling compound further comprises a second reactive group; and forming a chemical bond between the second reactive group on the coupling compound and a reactive group on a functional large molecular or macromolecular compound to provide no more than a monolayer of functional compound.

The invention also provides substrates having coatings prepared according to the methods of the invention. For example, there is provided herein substrates having an oleophilic, oleophobic, hydrophobic, hydrophilic, electron donating or electron withdrawing, acidic or basic, electrostatic or anti-electrostatic, catalytic, and/or bioactive or bioinert functional monolayer or sub-monolayer coating.

In some embodiments, the invention provides a method for forming a functional layer on a substrate, the method comprising: (i) a first step of forming a first layer of a coupling compound on a surface of the substrate by contacting and chemically bonding the coupling compound to the substrate, wherein: the coupling compound comprises a first reactive group and a second reactive group, provided that the first reactive group and the second reactive group may be the same or different; the surface of the substrate comprises surface-exposed reactive groups; the first reactive group of the coupling compound chemically bonds with a surface exposed reactive group; and the second reactive group of the coupling compound remains unreacted with the surface; and (ii) a second step of forming a functional layer of a functional layer compound by contacting and chemically bonding the functional layer compound to the coupling compound, wherein: the functional layer compound comprises a reactive group and a functional group; the second reactive group of the coupling compound chemically bonds with the reactive group of the functional layer compound; and the second step is optionally carried out in the presence of a catalyst.

In some embodiments, the invention provides a method for preparing a functionally coated substrate, the method comprising: (i) forming a chemical bond between a reactive group attached to a substrate and a first reactive group on a coupling compound such that the coupling compound is chemically bounded to the surface, wherein the coupling compound further comprises a second reactive group; and (ii) forming a chemical bond between the second reactive group on the coupling compound and a reactive group on a functional layer compound.

In some embodiments, the invention provides a functionalized substrate prepared according to any of the methods disclosed herein.

Further aspects of the invention will be apparent from the disclosure, including from the examples and claims provided herein.

### BRIEF DESCRIPTION OF THE DRAWINGS

FIG. 1 provides a schematic depiction of an embodiment according to the invention.

FIG. 2 provides a depiction of a specific embodiment according to the invention.

FIG. 3 provides data (contact angles, etc.) derived from an uncoated surface and various coated surfaces.

### DETAILED DESCRIPTION OF THE INVENTION

Before the present methods, materials, and coatings are disclosed and described, it is to be understood that this invention is not limited to specific materials or coating conditions, as such may, of course, vary. It is also to be understood that the terminology used herein is for the purpose of describing particular embodiments only and is not intended to be limiting.

Unless defined otherwise, all technical and scientific terms used herein have the meaning commonly understood by one of ordinary skill in the art to which the invention pertains. Although any methods and materials similar or equivalent to those described herein may be useful in the practice or testing of the present invention, preferred methods and materials are described below. Specific terminology of particular importance to the description of the present invention is defined below.

The term “nonwetting” as used herein refers to a substrate surface, which has a very low compatibility with liquids and semiliquids such as waxes, due to low surface tension and/or lack of chemical affinity. The term “nonwetting” may refer to hydrophobic and waterproofing characteristics, or to oleophobic characteristics.

The term “alkyl” as used herein refers to a branched, unbranched or cyclic saturated hydrocarbon group of 1 to about 50 carbon atoms, such as methyl, ethyl, n-propyl, isopropyl, n-butyl, isobutyl, t-butyl, octyl, decyl, tetradecyl, hexadecyl, eicosyl, tetracosyl and the like. Preferred alkyl groups herein may contain 1 to about 36, more typically 1 to 10, carbon atoms. The term “lower alkyl” intends an alkyl group of 1 to 6 carbon atoms, preferably 1 to 4 carbon atoms. The alkyl groups present on the polymers described herein may be unsubstituted or they may be substituted with one or more substituents including functional groups (e.g., amine, hydroxyl, an olefinic group such as a vinyl or an allyl group), or the like. “Substituted alkyl” refers to alkyl substituted with one or more substituent groups, and this includes instances wherein two hydrogen atoms from the same carbon atom in an alkyl substituent are replaced, such as in a carbonyl group (i.e., a substituted alkyl group may include a —C(═O)— moiety). Other substituents include halogen, ether, hydroxyl, amine functional groups, etc. as defined in more detail below. The terms “heteroatom-containing alkyl” and “heteroalkyl” refer to an alkyl substituent in which at least one carbon atom is replaced with a heteroatom, such as O, S, P, or N, as described in further detail infra. If not otherwise indicated, the terms “alkyl” and “lower alkyl” include linear, branched, cyclic, unsubstituted, substituted, and/or heteroatom-containing alkyl or lower alkyl, respectively

The term “alkylene” as used herein refers to a difunctional saturated branched or unbranched hydrocarbon chain containing from 1 to 50 carbon atoms. “Lower alkylene” refers to alkylene linkages containing from 1 to 12 carbon atoms, and includes, for example, methylene (—CH₂—), ethylene (—CH₂CH₂—), propylene (—CH₂CH₂CH₂—), 2-methylpropylene (—CH₂—CH(CH₃)—CH₂—), hexylene (—(CH₂)₆—) and the like. Similarly, the terms “alkenylene,” “alkynylene,” “arylene,” “alkarylene,” and “aralkylene” refer to difunctional (i.e., linking) alkenyl, alkynyl, aryl, alkaryl, and aralkyl groups, respectively.

The term “alkenyl” as used herein refers to a linear, branched or cyclic hydrocarbon group of 2 to about 50 carbon atoms containing at least one double bond, such as ethenyl, n-propenyl, isopropenyl, n-butenyl, isobutenyl, octenyl, decenyl, tetradecenyl, hexadecenyl, eicosenyl, tetracosenyl, and the like. Generally, although again not necessarily, alkenyl groups herein may contain 2 to about 36 carbon atoms, and for example may contain 2 to 12 carbon atoms. The term “lower alkenyl” intends an alkenyl group of 2 to 6 carbon atoms. The term “substituted alkenyl” refers to alkenyl substituted with one or more substituent groups, and the terms “heteroatom-containing alkenyl” and “heteroalkenyl” refer to alkenyl in which at least one carbon atom is replaced with a heteroatom. If not otherwise indicated, the terms “alkenyl” and “lower alkenyl” include linear, branched, cyclic, unsubstituted, substituted, and/or heteroatom-containing alkenyl and lower alkenyl, respectively. Similarly, the term “olefin,” as in an “olefinic compound” as used herein refers to a mono-unsaturated or di-unsaturated hydrocarbon of 2 to 36 carbon atoms, wherein in preferred embodiments a carbon-carbon double bond is positioned between the terminal 2 carbon atoms. Preferred olefinic groups within this class are sometimes herein designated as “lower olefinic groups,” intending a hydrocarbon containing 2 to 18 carbon atoms containing a single terminal double bond. The latter moieties may also be termed “lower alkenyl.” In some cases, it is a part of a silicon containing compound. Typically, but not necessarily, compounds containing olefinic groups are in a liquid form during use in the methods of the disclosure.

The term “alkynyl” as used herein refers to a linear or branched hydrocarbon group of 2 to 50 carbon atoms containing at least one triple bond, such as ethynyl, n-propynyl, and the like. Generally, although again not necessarily, alkynyl groups herein may contain 2 to about 18 carbon atoms, and such groups may further contain 2 to 12 carbon atoms. The term “lower alkynyl” intends an alkynyl group of 2 to 6 carbon atoms. The term “substituted alkynyl” refers to alkynyl substituted with one or more substituent groups, and the terms “heteroatom-containing alkynyl” and “heteroalkynyl” refer to alkynyl in which at least one carbon atom is replaced with a heteroatom. If not otherwise indicated, the terms “alkynyl” and “lower alkynyl” include linear, branched, unsubstituted, substituted, and/or heteroatom-containing alkynyl and lower alkynyl, respectively.

The term “alkoxy” refers to an alkyl group bound through an oxygen linkage. In some embodiments, the alkyl group binds through the oxygen linkage to a non-carbon element, typically to a silicon atom in this disclosure. “Lower alkoxy” intends an alkoxy group containing 1 to 10, more preferably 1 to 7, carbon atoms.

The term “aryl” as used herein refers to an aromatic species having 1 to 3 rings, but typically intends a monocyclic or bicyclic moiety, e.g., phenyl or 1- or 2-naphthyl groups. Optionally, these groups are substituted with 1 to 4, more preferably 1 to 2, substituents such as those described herein, including lower alkyl, lower alkoxy, hydroxyl, amino, and/or nitro. Aryl groups may, for example, contain 6 to 50 carbon atoms, and as a further example, aryl groups may contain 6 to 12 carbon atoms. For example, aryl groups may contain one aromatic ring or two fused or linked aromatic rings, e.g., phenyl, naphthyl, biphenyl, diphenylether, diphenylamine, benzophenone, and the like. “Substituted aryl” refers to an aryl moiety substituted with one or more substituent groups, and the terms “heteroatom-containing aryl” and “heteroaryl” refer to aryl substituent, in which at least one carbon atom is replaced with a heteroatom, as will be described in further detail infra. If not otherwise indicated, the term “aryl” includes unsubstituted, substituted, and/or heteroatom-containing aromatic substituents.

The term “aralkyl” refers to an alkyl group with an aryl substituent, and the term “alkaryl” refers to an aryl group with an alkyl substituent, wherein “alkyl” and “aryl” are as defined above. In general, aralkyl and alkaryl groups herein contain 6 to 50 carbon atoms. Aralkyl and alkaryl groups may, for example, contain 6 to 20 carbon atoms, and as a further example, such groups may contain 6 to 12 carbon atoms.

The term “amino” intends an amino group —NR₂ where R is hydrogen or an alternative substituent, typically lower alkyl. The term “amino” is thus intended to include primary amino (i.e., NH₂), “alkylamino” (i.e., a secondary amino group containing a single alkyl substituent), and “dialkylamino” (i.e., tertiary amino group containing two alkyl substituents).

The term “heteroatom-containing” as in a “heteroatom-containing alkyl group” (also termed a “heteroalkyl” group) or a “heteroatom-containing aryl group” (also termed a “heteroaryl” group) refers to a molecule, linkage or substituent in which one or more carbon atoms are replaced with an atom other than carbon, e.g., nitrogen, oxygen, sulfur, phosphorus or silicon, typically nitrogen, oxygen or sulfur. Similarly, the term “heteroalkyl” refers to an alkyl substituent that is heteroatom-containing, the term “heterocyclic” refers to a cyclic substituent that is heteroatom-containing, the terms “heteroaryl” and heteroaromatic” respectively refer to “aryl” and “aromatic” substituents that are heteroatom-containing, and the like. Examples of heteroalkyl groups include alkoxyaryl, alkylsulfanyl-substituted alkyl, N-alkylated amino alkyl, and the like. Examples of heteroaryl substituents include pyrrolyl, pyrrolidinyl, pyridinyl, quinolinyl, indolyl, furyl, pyrimidinyl, imidazolyl, 1,2,4-triazolyl, tetrazolyl, etc., and examples of heteroatom-containing alicyclic groups are pyrrolidino, morpholino, piperazino, piperidino, tetrahydrofuranyl, etc.

“Hydrocarbyl” refers to univalent hydrocarbyl radicals containing 1 to about 50 carbon atoms, including 1 to about 36 carbon atoms, further including 1 to about 18 carbon atoms, and further including about 1 to 12 carbon atoms, including linear, branched, cyclic, saturated and unsaturated species, such as alkyl groups, alkenyl groups, aryl groups, and the like. “Substituted hydrocarbyl” refers to hydrocarbyl substituted with one or more substituent groups, and the term “heteroatom-containing hydrocarbyl” refers to hydrocarbyl in which at least one carbon atom is replaced with a heteroatom such as O, N, P, Si, or S. Unless otherwise indicated, the term “hydrocarbyl” is to be interpreted as including substituted and/or heteroatom-containing hydrocarbyl moieties.

The term “ether” includes both mono and polyethers and refers to groups having a chain containing carbon and oxygen and each of these units consists of 2 to 6 carbons for each oxygen atom. Examples are diethyl and dipropyl ethers, polyethyleneoxide, polyprolyleneoxide, polyethelene glycol, polybuteleneoxide.

“Halo” or “halogen” refers to fluoro, chloro, bromo or iodo, and usually relates to halo substitution for a hydrogen atom in an organic compound.

As used herein, the term “perfluoro,” such as a perfluoro group, perfluoro monomer, perfluoro oligomer or perfluoro polymer, refers to a moiety or compound in which fluoro atoms substitute for hydrogen atom completely or almost completely. In some embodiments of perfluoro groups, the hydrogen atoms on between 1 and 3 carbons at a terminus or at a terminal bonding site (i.e., where the group attaches to a substrate or to another chemical moiety) are not replaced with fluoro atoms. Perfluoro groups further include polycarbon or polyether chains having the hydrogen atoms replaced with fluoro atoms.

The terms “halocarbyl” and “halocarbon” refer to hydrocarbyl groups (as defined above) for which one or more hydrogen radicals are replaced with halo radicals. Similarly, the term “perhalocarbyl” refers to hydrocarbyl groups for which all hydrogen radicals are replaced with halo radicals. The terms “halocarbyl” and “halocarbon” include perhalocarbyl, and further includes fluorocarbyl groups, perfluorinated hydrocarbyl groups, chlorocarbyl groups, perchlorinated hydrocarbyl groups, bromocarbyl groups, perbrominated hydrocarbyl groups, iodocarbyl groups, and periodinated hydrocarbyl groups. Similarly, the term “haloether” refers to an ether group in which one or more hydrogen radicals are replaced with halo radicals, and the term “perhaloether” refers to an ether in which all hydrogen radicals are replaced with halo radicals. The term “haloether” includes perhaloethers, unless otherwise specified.

By “substituted” as in “substituted hydrocarbyl,” “substituted alkyl,” “substituted aryl,” and the like, as alluded to in some of the aforementioned definitions, is meant that in the hydrocarbyl, alkyl, aryl, or other moiety, at least one hydrogen atom bound to a carbon (or other) atom is replaced with one or more non-hydrogen substituents. Examples of such substituents include, without limitation: functional groups such as halo, hydroxyl, sulfhydryl, C₁-C₂₄ alkoxy, C₂-C₂₄ alkenyloxy, C₂-C₂₄ alkynyloxy, C₅-C₂₀ aryloxy, acyl (including C₂-C₂₄ alkylcarbonyl (—CO-alkyl) and C₆-C₂₀ arylcarbonyl (—CO-aryl)), acyloxy (—O-acyl), C₂-C₂₄ alkoxycarbonyl (—(CO)—O-alkyl), C₆-C₂₀ aryloxycarbonyl (—(CO)—O-aryl), halocarbonyl (—CO)—X where X is halo), C₂-C₂₄ alkylcarbonato (—O—(CO)—O-alkyl), C₆-C₂₀ arylcarbonato (—O—(CO)—O-aryl), carboxy (—COOH), carboxylato (—COO—), carbamoyl (—(CO)—NH₂), mono-substituted C₁-C₂₄ alkylcarbamoyl (—(CO)—NH(C₁-C₂₄ alkyl)), di-substituted alkylcarbamoyl (—(CO)—N(C₁-C₂₄ alkyl)₂), mono-substituted arylcarbamoyl (—(CO)—NH-aryl), thiocarbamoyl (—(CS)—NH₂), carbamido (—NH—(CO)—NH₂), cyano (—C≡N), isocyano (—N+≡C—), cyanato (—O—C≡N), isocyanato (—O—N≡C—), isothiocyanato (—S—C≡N), azido (—N═N+═N—), formyl (—(CO)—H), thioformyl (—(CS)—H), amino (—NH₂), mono- and di-(C₁-C₂₄ alkyl)-substituted amino, mono- and di-(C₅-C₂₀ aryl)-substituted amino, C₂-C₂₄ alkylamido (—NH—(CO)-alkyl), C₅-C₂₀ arylamido (—NH—(CO)-aryl), imino (—CR═NH where R=hydrogen, C₁-C₂₄ alkyl, C₅-C₂₀ aryl, C₆-C₂₀ alkaryl, C₆-C₂₀ aralkyl, etc.), alkylimino (—CR═N(alkyl), where R=hydrogen, alkyl, aryl, alkaryl, etc.), arylimino (—CR═N(aryl), where R=hydrogen, alkyl, aryl, alkaryl, etc.), nitro (—NO₂), nitroso (—NO), sulfo (—SO₂—OH), sulfonato (—SO₂—O—), C₁-C₂₄ alkylsulfanyl (—S-alkyl; also termed “alkylthio”), arylsulfanyl (—S-aryl; also termed “arylthio”), C₁-C₂₄ alkylsulfinyl (—(SO)-alkyl), C₅-C₂₀ arylsulfinyl (—(SO)-aryl), C₁-C₂₄ alkylsulfonyl (—SO₂-alkyl), C₅-C₂₀ arylsulfonyl (—SO₂-aryl), phosphono (—P(O)(OH)₂), phosphonato (—P(O)(O—)₂), phosphinato (—P(O)(O—)), phospho (—PO₂), and phosphino (—PH₂), mono- and di-(C₁-C₂₄ alkyl)-substituted phosphino, mono- and di-(C₅-C₂₀ aryl)-substituted phosphino; and the hydrocarbyl moieties C₁-C₂₄ alkyl (including C₁-C₁₈ alkyl, further including C₁-C₁₂ alkyl, and further including C₁-C₆ alkyl), C₂-C₂₄ alkenyl (including C₂-C₁₈ alkenyl, further including C₂-C₁₂ alkenyl, and further including C₂-C₆ alkenyl), C₂-C₂₄ alkynyl (including C₂-C₁₈ alkynyl, further including C₂-C₁₂ alkynyl, and further including C₂-C₆ alkynyl), C₅-C₃₀ aryl (including C₅-C₂₀ aryl, and further including C₅-C₁₂ aryl), and C₆-C₃₀ aralkyl (including C₆-C₂₀ aralkyl, and further including C₆-C₁₂ aralkyl). In addition, the aforementioned functional groups may, if a particular group permits, be further substituted with one or more additional functional groups or with one or more hydrocarbyl moieties such as those specifically enumerated above. Analogously, the above-mentioned hydrocarbyl moieties may be further substituted with one or more functional groups or additional hydrocarbyl moieties such as those specifically enumerated.

When the term “substituted” appears prior to a list of possible substituted groups, it is intended that the term apply to every member of that group. For example, the phrase “substituted alkyl and aryl” is to be interpreted as “substituted alkyl and substituted aryl.”

Unless otherwise specified, reference to an atom is meant to include isotopes of that atom. For example, reference to H is meant to include 1H, 2H (i.e., D) and 3H (i.e., T), and reference to C is meant to include ¹²C and all isotopes of carbon (such as ¹³C).

“Siloxanes” as used herein are compounds which contain one or more silicon-oxygen bonds and may or may not contain cyclic units. The terms “polysiloxane” and “siloxane polymer” as used herein are intended to include oligomeric and polymeric siloxanes, i.e., compounds, which include two or more monomeric siloxane units.

“Silane” or “organosilane” as used herein refers to a mono or poly organosilane compound comprising one or more silicon-carbon bonds, or a polymer of such a compound, and may further contain other inorganic elements. Unless otherwise specified, silanes include siloxanes, siloxazanes, and silazanes, and furthermore include repeating silyl units, or “polysilane” species. “Silyl,” as used herein, refers to a silane radical, such that the silyl is attached as a substituent to a compound (analogous to “methyl” as a “methane” group attached as a substituent to a compound). Unless otherwise specified, “silyl” includes siloxyl, siloxazyl, and silazyl, and furthermore includes repeating silyl units, or “polysilyl” species.

It will be appreciated that the above-provided definitions may in some cases be overlapping in scope, such that a particular chemical moiety may be encompassed by more than one term. Furthermore, throughout this specification, it will be appreciated that specification of a generic term as well as a specific example encompassed by the generic term is not meant to imply that the specific example is excluded from other instances where it is not specifically called out. For example, recitation of a chemical moiety being selected from “alkyl, methyl, etc.” is not intended to imply that “methyl” should be excluded from the definition of “alkyl” unless specified otherwise.

The term “smudge” as used herein, and unless specified otherwise, refers to a residue that is on a surface but not covalently attached to the surface. Smudges include smears, stains, blemishes, and other marks. Typically, although not necessarily, smudges comprise dirt, grease, and/or oil. For example, smudges may comprise one or more hydrocarbons, fatty acids, proteins, and/or compounds commonly found on human skin, as well as combinations thereof.

Unless specified otherwise, the terms “chemically bonded,” “chemically attached,” and “chemically linked” mean covalent bonding.

The methods and materials described herein are suitable for preparing coatings on substrates. Such coatings include functional coatings composed of monolayer or sub-monolayer of large molecules or macromolecules. In preferred embodiments, the coatings are chemically bonded to the substrate, thereby providing a robust and stable attachment. In some embodiments, the coatings impart a functional property to the substrate. For example, as described in more detail infra, surface coatings prepared according to the invention may impart to the substrate one or more surface properties such as hydrophobicity, hydrophilicity, oleophobicity (also referred to as lipophobicity), oleophilicity (also referred to as lipophilicity), lubricity, acidity, basisity, electrostatics, antielectrostatics, bioactivity, bioinertness, selective chemical affinity, etc. In some embodiments, the coatings of the invention provide a smudge-resistant surface coating, such that the substrate/coating combination is resistant to smudges. In some embodiments, the coatings of the invention provide an “easy-to-clean” surface, meaning that, relative to an uncoated substrate surface, smudges are easier to remove (e.g., wiped away using fewer wipes, less pressure, etc.) from a substrate coated according to the invention.

Qualitatively, by “smudge-resistant” is meant that, compared with the substrate alone: (a) smudges (i.e., dirt, oil, grease, and the like) are less likely to attach to the surface of the substrate/coating combination; (b) smudges that attach to the surface is easier to remove from the substrate/coating combination; and/or (c) removal of any smudges from the surface of the substrate/coating combination is less likely to leave a residue. Quantitatively, by “smudge-resistant” is meant that, compared with the substrate alone, the surface of the substrate/coating combination: (a) is more oleophobic (e.g., by 5%, 10%, 15%, 20%, 25%, 30%, 40%, 50%, 60%, 70%, 80%, or 90%); (b) is more hydrophobic (e.g., by 5%, 10%, 15%, 20%, 25%, 30%, 40%, 50%, 60%, 70%, 80%, or 90%); (c) has a higher water contact angle (e.g., by 5%, 10%, 15%, 20%, 25%, 30%, 40%, 50%, 60%, 70%, 80%, or 90%); and/or (d) has a higher oil contact angle (e.g., by 5%, 10%, 15%, 20%, 25%, 30%, 40%, 50%, 60%, 70%, 80%, or 90%).

In some embodiments, the invention provides a method for forming surface coatings that are chemically bonded to the surface. As described in more detail infra, preferred such methods are two-step methods in which a coupling compound is first chemically bonded to the surface, and a surface functional layer compound is then chemically bonded to the surface via attachment to the coupling compound.

In some embodiments, the coatings of the invention provide an electrostatic coating. Such coatings minimize the buildup of static electrical charges on the substrate by providing a surface with a modified electrical resistance.

In some embodiments of the present invention, a method is provided for preparing a layer (also referred to herein as a “coating”) on a substrate. The method comprises providing a substrate, chemically bonding a coupling compound to the substrate, and then chemically bonding a functional layer compound to the coupling compound. In this way, the functional layer compound is chemically bonded to the substrate via the coupling compound. The functional layer compound forms a monolayer or sub-monolayer coating on the surface, and in preferred embodiments the functional layer compound provides a special functionality to the surface not exhibited by, or even contrasting with, the innate material surface characteristics (i.e., the coating has one or more properties such as those described herein). Accordingly, coatings of the invention include monolayers of functional layer compound covalently attached to substrate surfaces via a coupling compound. The layer of coupling compound may be a monolayer or may comprise more than a monolayer (e.g., a bilayer, etc.). Such layers may be referred to as “ultrathin coatings,” or “chemically grafted coatings,” or “chemically bonded coatings,” or some combination thereof.

In some embodiments, the coatings of the invention are covalently bonded to the substrate—i.e., the coupling compound is covalently attached to the substrate via one or more reactive groups of the coupling compound, and the functional layer compound is covalently bonded to the coupling compound via one or more reactive groups of the coupling compound and/or the functional layer compound. The bonding present between functional layer compound, the coupling compound, and substrate should be durable enough to provide long-term stability against the mechanical and chemical conditions that would remove or degrade the coating in the absence of such bonding.

By “providing a substrate” is meant that the substrate may be obtained from a general supplier (e.g., purchased), or the substrate may be custom prepared specifically for use with the methods of the invention. Preparation of the substrate may include, for example, patterning the substrate (e.g., using lithography and etching), cleaning the substrate, and/or forming surface exposed reactive groups (as described in more detail infra).

The substrate may comprise, for example, a material selected from glass, metals, organic polymers (i.e., plastics), inorganic polymers, metal oxides, ceramics, carbon, or combinations thereof. The substrate may be transparent, flat, curved, or angled, and may be smooth or textured. The substrate may be patterned, e.g., the substrate may include surface structures such as microelectronic devices and the like, or textured with a surface roughness ranging from a few nanometers to a few millimeters. The substrate may be a layered structure, and may include various embedded components or layers such as microelectronics, microcircuitry, and the like. The substrate can be already coated with other functional or protective layers such as antiglare or scratch resistance coating.

In some embodiments, in order to attach the coupling compound to the substrate, as described in more detail infra, the substrate surface comprises reactive groups (also herein called “substrate reactive groups” or “surface exposed reactive groups”) exposed on one or more surfaces of the substrate. For example, metallic, glass and ceramic substrates may possess (either inherently or as a result of a pretreatment process) metal hydroxyl reactive bonds at their surface. Another example is an organic substrate possessing surface functionalities containing carbon-oxygen single bonds or double bonds after being treated by corona discharge, ozone plasma or another gentle oxidation technique. The substrate reactive groups are not limited to any particular chemical moiety, provided that the reactive groups are able to react or complex with the coupling compound to form a chemical bond attaching the coupling compound to the substrate.

In the case of glass or ceramics, the preferred coupling with the surface is via condensation of hydroxyl groups at the surface with M-OH group or groups of the coupling agent, preferably with Si—OH.

In some embodiments, the substrate reactive groups require modification prior to reacting with the coupling compound. For example, the reactive groups may need to be oxidized or deprotected via reaction with a suitable oxidation or deprotecting agent. The identity of the surface exposed reactive groups, and whether or not such groups require protecting groups, will depend, for example, upon the intended application and desired surface properties, the identity of the coupling compound, and the identity of the substrate material. Suitable reactive groups include those reactive groups described herein above. For example, the reactive groups may be selected from hydroxyl, protected hydroxyl (e.g., organic or inorganic ethers such as siloxanes), carboxylic acid, protected carboxylic acids (such as alkyl esters and aryl esters), amide, or combinations thereof.

In some embodiments, the surface exposed reactive groups are naturally occurring on the substrate material—i.e., no particular procedure is required to obtain the surface exposed reactive groups. For example, glass substrates ordinarily have surface exposed hydroxyl groups. Although procedures are available for obtaining additional hydroxyl groups on glass surfaces, such procedures are typically option in the instant methods. As a further example, hydroxyl groups and/or oxo (M-O-M) groups are ordinarily present on the surface of metal oxide substrates. Accordingly, some metal oxide substrates may require no further modification in order to be reactive with the coupling compound. Again, procedures are available (including those described herein) for obtaining additional reactive groups on the substrate surfaces, and such procedures may be included in the methods of the invention.

Where surface exposed reactive groups are not naturally occurring on the substrate surface, or where additional reactive groups are desired, the surface-exposed reactive groups may be obtained, for example, by treating the substrate surface with a reagent capable of forming reactive groups attached to the surface. Thus, in some embodiments, the surface exposed reactive groups are created on the surface specifically for subsequent reaction with the coupling compound. For example, oxidation of a metal or organic substrate with an appropriate oxidizing reagent is a method for forming hydroxyl groups and other oxygen-containing reactive groups on the surface of the substrate. Appropriate oxidizing reagents are known in the art, and include, for example, electromagnetic radiation such as UV, X-rays, plasmas, and chemical oxidizers such as permanganate salts (e.g., potassium, sodium, or lithium permanganate), O₂, ozone, peroxides (e.g., benzoyl peroxide or hydrogen peroxide), anodizing and the like. After generation of the surface exposed reactive groups, the substrate may be optionally cleaned, provided that any methods of cleaning do not significantly destroy or degrade the substrate and the surface exposed reactive groups.

As mentioned previously, in some embodiments, the surface exposed reactive groups may be protected reactive groups. This may be particularly appropriate where the reactive groups are highly reactive, and/or where the surface may be exposed to further processing, and/or the surface may be exposed to otherwise inhospitable conditions prior to reaction with the coupling compound, and/or where it is desired to shield the surface exposed reactive groups from other reactive species. Suitable protecting groups will depend, for example, upon the identity of the surface exposed reactive groups, the conditions to which the reactive groups will be exposed, the desired method of protecting and deprotecting, and other such considerations. Examples of protected reactive groups include, for example, esters and amides (i.e., protected acid groups), ethers (i.e., protected hydroxyl groups), and the like. Reference may be had to the relevant literature for suitable protecting groups (for example, Greene et al., Protecting Groups in Organic Synthesis, 3^{rd} Ed., Wiley, New York, 1999). In cases where the surface exposed reactive groups are protected, such groups are deprotected prior to or during reaction with the coupling compound. Deprotection may be carried out using reagents appropriate for the particular protecting group.

Surface exposed reactive groups may be present, generated, protected, and/or deprotected on the substrate in a patterned fashion, when desired. For example, using mask and lithography techniques, it is within the scope of the invention to oxidize certain regions of the substrate while not oxidizing other regions. The oxidized regions will contain surface exposed reactive groups, and therefore the coatings of the invention will form mostly or exclusively on the oxidized regions.

The surface exposed reactive groups are preferably distributed evenly across the regions of the substrate upon which they are present. The density of the reactive groups will depend, for example, upon the method by which they are generated or obtained. Preferably, the density of the surface exposed reactive groups is at least sufficient to allow the coupling compound to form a substantially homogeneous layer chemically attached to the substrate.

In one example, a glass substrate is used, and the native (i.e., naturally occurring) hydroxyl groups on the surface of the glass substrate are used without modification as the surface exposed reactive groups. The substrate is cleaned with solvent and/or water washes prior to exposure to the coupling compound.

In some embodiments, the substrate surface does not have surface exposed reactive groups. Such embodiments require an appropriate coupling (see discussion below) that is able to chemically bond to the surface without reacting with a reactive group. For example, when the coupling compound comprises a thiol group (—SH) or a disulfide group (—S—S—), the substrate may comprise a gold surface (e.g., the substrate is gold or the substrate is coated with a layer of gold). Thiol and disulfide groups form adequate chemical linkages to gold surfaces and other metals forming strong bonds with sulfur.

The coatings of the invention are prepared in a method that comprises chemically bonding a coupling compound to the substrate. Attachment of the coupling compound provides a linking (i.e., coupling) layer covering the substrate surface. The coupling compound comprises at least one first reactive group capable of bonding to the substrate surface (e.g., to the surface exposed reactive groups) and at least one second reactive group capable of bonding to the functional layer compound. The coupling compound may further comprise additional reactive groups that are identical to the first reactive group and/or to the second reactive group. Typically, although not necessarily, the first and second reactive groups are different reactive groups. They can also be the same type of group (as described below). In some embodiments where the first and second reactive groups are the same type of group, the second reactive group may be protected such that it does not react with the surface exposed reactive groups. Such protection may be chemical (i.e., by a chemical protecting group) or may be physical (i.e., by sterically positioning the second reactive group such that, once the first reactive group has reacted with the surface, the second reactive group is oriented away from, and not able to react with, the surface). Throughout this disclosure, the first reactive group may be referred to as a first “type” of reactive group, and the second reactive group may be referred to as a second “type” of reactive group.

In preferred embodiments, the coupling compound is a small organic, organosilicon or organometallic molecule (i.e., an organic molecule having a molecular weight of less than about 2000 g/mol, or less than about 1500 g/mol, or less than about 1200 g/mol, or less than about 1000 g/mol, or less than about 800 g/mol, or less than about 700 g/mol, or less than about 500 g/mol, or less than about 350 g/mol).

The first reactive group of the coupling compound (also referred to herein as a complementary reactive group) is a reactive group capable of forming a chemical linkage with the surface of the substrate. In some embodiments, the first reactive group of the coupling compound is capable of reacting with the surface exposed reactive groups of the substrate. The reaction results in a chemical linkage. In preferred embodiments, the reaction results in a covalent bond. Accordingly, the identity of the first reactive group will depend upon the identity of the surface and/or the surface exposed reactive groups of the substrate desired to be coated. Although in some embodiments the first reactive group is a group that is capable of self-reaction (i.e., the first reactive groups of two coupling compounds may react with each other), typically, it is desired for the first reactive group to be at least as reactive (or more reactive) with the substrate surface. This is desirable so that the coupling compound forms chemical bonding with the substrate rather than forming linkages only with other coupling compounds. Examples of first reactive groups include hydroxyl (including C—OH and Si—OH as well as polyhydroxyl groups such as —Si(OH)ₙ, where n is 1 to 3), sulfhydryl, C₁-C₂₄ alkoxy (including C—OR, O═C—OR and Si—OR as well as polyalkoxy groups such as —Si(OR)ₙ, where n is 1 to 3 and R is alkyl), C₅-C₂₀ aryloxy (including C—OR and Si—OR as well as polyaryloxy groups such as —Si(OR)ₙ, where n is 1 to 3 and R is aryl), mixed aryloxy/alkoxy groups (such as —Si(OR)ₙ, where n is 1 to 3 and at least one R is aryl and at least one R is alkyl), acyl (including C₂-C₂₄ alkylcarbonyl and C₆-C₂₀ arylcarbonyl), acyloxy, C₂-C₂₄ alkoxycarbonyl, C₆-C₂₀ aryloxycarbonyl, halocarbonyl, C₂-C₂₄ alkylcarbonato, C₆-C₂₀ arylcarbonato, carboxy, carboxylato, carbamoyl, mono-substituted C₁-C₂₄ alkylcarbamoyl, di-substituted alkylcarbamoyl, mono-substituted arylcarbamoyl, thiocarbamoyl, carbamido, cyano, isocyano, cyanato, isocyanato, isothiocyanato, azido, formyl, thioformyl, thiol, amino, mono- and di-(C₁-C₂₄ alkyl)-substituted amino, mono- and di-(C₅-C₂₀ aryl)-substituted amino, C₂-C₂₄ alkylamido, C₅-C₂₀ arylamido, imino, alkylimino, arylimino, nitro, nitroso, sulfo, sulfonato, C₁-C₂₄ alkylsulfanyl, arylsulfanyl, C₁-C₂₄ alkylsulfinyl, C₅-C₂₀ arylsulfinyl, C₁-C₂₄ alkylsulfonyl, C₅-C₂₀ arylsulfonyl, phosphono, phosphonato, phosphinato, phospho, and phosphino, mono- and di-(C₁-C₂₄ alkyl)-substituted phosphino, mono- and di-(C₅-C₂₀ aryl)-substituted phosphino. In some embodiments, the first reactive group is capable of forming a chemical linkage with substrate surfaces that do not have reactive groups, such as the thiol/gold example mentioned previously. Other useful reactive groups include SiXₙ, where X is halo (Cl, F, Br or I), which can directly react with M-OH groups at the surface. X can be O₂CR″ or NR″R′″ wherein R″ is selected from lower alkyl, or organosilyl, and R′″ is selected from H, lower alkyl, or organosilyl. In the cases of Si—OR, SiO₂CR″ and SiNR″R′″ a small amount of water may be required to partially hydrolyze the protecting groups and allow easier bonding to the substrate. Excessive amounts of water is typically not desired, however, since uncontrolled hydrolysis and formation of Si—OH can lead to undesired self condensation reactions of the coupling compounds (i.e., reaction with other coupling compounds). Other reactive groups can be any functional groups that react and form chemical bonds with the surface reactive groups mentioned above. Other examples of first reactive groups can be phosphates, phosphonates, sulfates, sulfonates, and thiols that have preferential affinities to certain metals and inorganic materials. First reactive groups such as carboxylic acid, amine, epoxy, isocyanate, oxime, vinyl and others that can react with organic materials are included.

Under certain processing conditions and typically in cases where the surface reactive groups can react with themselves after deprotection, such as occurs by hydrolyzing Si—OR to Si—OH followed by condensation coupling to Si—O—Si bonds, it is a preferred situation to avoid the hydrolysis of the surface Si—OR groups by reaction with water in the solution. This can be accomplished by allowing the first reactive groups of the coupling compound, such as M-OH groups, to react directly with the surface Si—OR groups, forming M-O—Si and thereby releasing ROH.

The second reactive group of the coupling compound (also referred to herein as a coupling reactive group) is a reactive group capable of reacting with a functional layer coating compound, as described in more detail infra. In some preferred embodiments, the second reactive group is unreactive or relatively unreactive with the surface exposed reactive groups compared with the reactivity of the first reactive group, such that the second reactive group remains unmodified when the coupling compound attaches to the substrate (via reaction of the first reactive group with the surface exposed reactive groups). By “relatively unreactive” is meant, for example, that the reaction rate of the first reactive group with surface exposed reactive groups is two times, or five times, or 10 times, or 100 times or more than 100 times greater than the reaction rate of the second reactive group with surface exposed reactive groups. A most preferred situation is wherein the second reactive group has a significantly lower affinity (e.g., half the affinity, or one third the affinity, or one fourth the affinity, or one fifth the affinity, or 10 times lower, or more than 10 times lower) to the substrate surface (i.e., surface exposed reactive groups) than the first reactive group. In some embodiments, the second reactive group has a similar reactivity to the first reactive group. Typically, in such embodiments, once the first reactive group is interacting with the surface, the second reactive group is sterically inhibited from sufficient further reaction with the substrate.

In the above situations the coupling compound can be preferentially bonded to the substrate through the first reactive group and any excessive amount of coupling compound that is not strongly bonded to the surface through the first reactive group can be washed out by immersing or rinsing the treated substrate with an appropriate solvent capable of dissolving free non-bonded coupling compounds.

Accordingly, the identity of the second reactive group will in some embodiments depend upon the identity of the reactive coating compound desired to be applied to the surface. Examples of suitable second reactive groups include those suitable for first reactive groups. It will be appreciated, however, that typically the identity of the first reactive group and the identity of the second reactive group will not be the same, or if they are the same then one of the groups (e.g., the second reactive group) will be in a protected form to ensure preferential reaction of the other group (e.g., the first reactive group with the surface exposed reactive groups). Further reactive groups may be present on the coupling compound. Such groups may be the same as, or different from, the first or second reactive groups on the coupling compound. In one embodiment, the coupling compound may comprise a plurality of reactive groups identical to either the first reactive group or the second reactive group, or a plurality of reactive groups identical to the first reactive group and a plurality of reactive groups identical to the second reactive group. For example, a trialkoxysilane compound comprises three reactive groups that may be suitable as first reactive groups to bond to the surface. Such compounds form crosslinks that allow the coupling compounds to form a network. For example, a coupling compound having a trialkoxysilane group acting as first reactive groups may form a crosslinked network covalently attached to a glass substrate having exposed hydroxyl groups. Such a crosslinked network is effective, for example, to increase the bonding strength between the surface and the coupling compound. In another example, a coupling compound having a trialkoxysilane acting as first reactive group and a reactive organic group such as silyl-aminopropyl or silyl-propyl-diethylenetriamine acting as second reactive groups may form a crosslinked network with the surface and maintain an available functional bonding site to the functional layer compound. It will be appreciated that combinations of such further reactive groups are within the scope of the invention. In preferred embodiments, the film formed by the coupling compound at the surface should be limited to a “monolayer” or a layer equivalent to a few “monolayers” (e.g., equivalent to 10 stacked monolayers, or 5 stacked monolayers, or 3 stacked monolayers, or 2 stacked monolayers). Also in preferred embodiments, the thickness of the coupling compound layer does not exceed 10 nm, or 9 nm, or 8 nm, or 7 nm, or 6 nm, or 5 nm, or 4 nm, or 3 nm, or 2 nm in order to provide very robust bonding yet cause no (or minimal) optical interference.

Such preferred coupling compound monolayers allow the formation of highly dense functional layer compound layers bonded to the surface. A good technique to provide such a monolayer is the immersion of the substrate in a dilute solution of the coupling compound and either sonicating the container and/or heating the solution with or without catalytic additives. Once the bonding is confirmed, the reacted substrate can be rinsed to eliminate any unbonded excess of the coupling compound.

Any of the reactive groups on the coupling compound may be protected reactive groups. For example, protection of the second function group during reaction of the coupling compound with the surface exposed reactive groups is a method for ensuring that the second reactive groups do not react with the surface exposed reactive groups. Protected second reactive groups can then be deprotected once the coupling compound has been attached to the surface, or can be deprotected during the reaction of the coupling compound with the reactive group of the functional layer compound. Through the use of protecting groups in this manner, the first and second reactive groups of the coupling compound may be the same group (e.g., hydroxyl groups, carboxylic acid or amine groups). Examples for protecting groups include alkoxy and carboxy compounds in the case of protecting M-OH and Si—OH reactive groups; alkoxy, anhydride, or amine in the case of carboxylic reactive groups; or hydrohalide salts in the case of amine reactive groups.

In some embodiments, the reactive groups of the coupling compound (either or both of the first or second reactive groups, i.e., either the group to be bonded to the substrate and/or the group to be bonded to the reactive coating compound) are selected from an amino (amido), a halo group, and combinations thereof, and such groups are bonded to a metal M within the coating compound, where M may be selected from Si, Al, B, Ti or Zr.

For example, the coupling compound may have the structure of formula (I)

(Rg¹)ₙ-X¹-(Rg²)ₘ (I)

wherein Rg¹ represents the first reactive group, Rg² represents the second reactive group, n and m are independently selected from integers greater than 0, and X¹ represents a linking moiety. Examples of X¹ include linking moieties selected from heteroatoms and the hydrocarbyl moieties C₁-C₂₄ alkylene (including C₁-C₁₈ alkylene, further including C₁-C₁₂ alkylene, and further including C₁-C₆ alkylene), C₂-C₂₄ alkenylene (including C₂-C₁₈ alkenylene, further including C₂-C₁₂ alkenylene, and further including C₂-C₆ alkenylene), C₂-C₂₄ alkynylene (including C₂-C₁₈ alkynylene, further including C₂-C₁₂ alkynylene, and further including C₂-C₆ alkynylene), C₅-C₃₀ arylene (including C₅-C₂₀ arylene, and further including C₅-C₁₂ arylene), and C₆-C₃₀ aralkylene (including C₆-C₂₀ aralkylene, and further including C₆-C₁₂ aralkylene), any of which may be substituted or heteroatom containing. Examples include oligo- or poly-ethers and oligo- or poly-amines. Examples further include alkyl, aryl, or mixed alkyl/aryl amino silanes (such as trialkyl amino silanes, dialkylaryl amino silanes, etc.) and alkyl, aryl, or mixed alkyl/aryl amino siloxanes (such as trialkoxy amino silanes, alkoxy/aryloxy amino silanes). Furthermore, any of these X¹ moieties may be halogenated, including perfluorinated or perchlorinated, such that X¹ is a halocarbyl moiety.

In some embodiments, the coupling compound is an amino silane compound, such as an aminoalkyl or aminoaryl silane. In some embodiments, the coupling compound has the formula

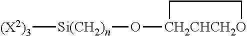

(glycidoxy, “epoxy” or a similar compound containing oxirane functionality) wherein n is an integer selected from 0, 1, 2, 3, and 4, and X² is a leaving group such as —OCH₃, —Cl, —OCH₂CH₃, —OC(═O)CH₃, alkyl groups such as methyl or ethyl (provided that no more than 2 of the groups are non-reactive alkyl), or combinations thereof. In some embodiments, the coupling compound has the formula (X²)₃—Si(CH₂)ₙ—O—C(═O)CH₃ or (X²)₃—Si(CH₂)ₙ—C(═O)OCH₃, wherein n and X² are as defined previously. In some embodiments, the coupling compound has the formula (X²)₃—Si(CH₂)ₙ—N(R¹)(R²), wherein n and X² are as defined previously, and R¹ and R² are independently selected from hydrogen, substituted or unsubstituted alkyl, and substituted or unsubstituted aryl.

Examples of the reactive groups (e.g., either Rg¹ or Rg², or both, particularly if one is a protected reactive group) are mentioned previously, and include hydroxyl (including C—OH and Si—OH as well as polyhydroxyl groups such as —Si(OH)ₙ, where n is 1 to 3), sulfhydryl, C₁-C₂₄ alkoxy (including C—OR, O═C—OR and Si—OR as well as polyalkoxy groups such as —Si(OR)ₙ, where n is 1 to 3 and R is alkyl), C₅-C₂₀ aryloxy (including C—OR and Si—OR as well as polyaryloxy groups such as —Si(OR)ₙ, where n is 1 to 3 and R is aryl), mixed aryloxy/alkoxy groups (such as —Si(OR)ₙ, where n is 1 to 3 and at least one R is aryl and at least one R is alkyl), acyl (including C₂-C₂₄ alkylcarbonyl and C₆-C₂₀ arylcarbonyl), acyloxy, C₂-C₂₄ alkoxycarbonyl, C₆-C₂₀ aryloxycarbonyl, halocarbonyl, C₂-C₂₄ alkylcarbonato, C₆-C₂₀ arylcarbonato, carboxy, carboxylato, carbamoyl, mono-substituted C₁-C₂₄ alkylcarbamoyl, di-substituted alkylcarbamoyl, mono-substituted arylcarbamoyl, thiocarbamoyl, carbamido, cyano, isocyano, cyanato, isocyanato, isothiocyanato, azido, formyl, thioformyl, thiol, amino, mono- and di-(C₁-C₂₄ alkyl)-substituted amino, mono- and di-(C₅-C₂₀ aryl)-substituted amino, C₂-C₂₄ alkylamido, C₅-C₂₀ arylamido, imino, alkylimino, arylimino, nitro, nitroso, sulfo, sulfonato, C₁-C₂₄ alkylsulfanyl, arylsulfanyl, C₁-C₂₄ alkylsulfinyl, C₅-C₂₀ arylsulfinyl, C₁-C₂₄ alkylsulfonyl, C₅-C₂₀ arylsulfonyl, phosphono, phosphonato, phosphinato, phospho, and phosphino, mono- and di-(C₁-C₂₄ alkyl)-substituted phosphino, mono- and di-(C₅-C₂₀ aryl)-substituted phosphino.

Some specific examples of coupling compounds include the following: aminopropyltriethyoxysilane (APTES); 3-aminopropyltrimethoxysilane (ATMS); 3-aminopropyltriisopropoxyoxysilane, 3-aminopropyltributoxysilane, 3-carboxypropyltrimethoxysilane, 3-carboxypropyltriethoxysilane, 3-syccinic-anhydride-propyltrimethoxysilane, aminophenyltrimethoxysilane, and others.

Mixtures of coupling compounds may be used in the methods of the invention. Such mixtures include binary, ternary, and quaternary mixtures.

In some embodiments, the coupling compound is a polyfunctional compound, for example an oligomer or polymer comprising monomer units each optionally having a first reactive group and/or a second reactive group, provided that the oligomer or polymer has at least one first reactive group and at least one second reactive group. In some embodiments, the polymer comprises monomer units (either in blocks or randomly distributed) that have neither first nor second reactive groups. In some embodiments the polymer is a copolymer comprising first monomer units that have first reactive groups and further comprising second monomer units that have second reactive groups. In some embodiments, the polymer comprises monomer units that have both first and second reactive groups. Examples of suitable polymers include polysiloxanes, polysilazanes, polyethers, polyamides, polyesters, polyacids, and copolymers thereof. For example a copolymer of acrylic acid and a monomer having an amine or protected amine as a side chain provides a polyfunctional compound capable of reacting with surface exposed reactive groups and with the functional layer compound.

The functional coatings of the invention comprise a functional layer compound chemically bonded to the coupling compound (and therefore chemically bonded to the substrate). The functional layer compound may be used to change the surface properties of the substrate by forming a coating chemically bonded to the substrate and altering the functionality of the surface (e.g., by providing a surface layer with a particular functionality different from the innate surface upon which the coating is disposed). Typically, at least two primary factors influence selection of the functional layer compound. First, since the functional layer compound forms a coating on the substrate surface (such as the top-most coating, i.e. the coating layer exposed to the environment), the chemical properties of the functional layer compound are chosen based on the properties desired of the coating and of the surface. Second, since the functional layer compound chemically bonds to the second functional group of the coupling compound, the identity of the reactive group or groups on functional layer compound are selected so as to have chemical reactivity and preferably also strong affinity with the second functional group of the coupling compound (e.g., Rg² in formula I).

In some embodiments, the functional layer compound is selected from hydrocarbyl (e.g., hydroxycarbyl, such as polyols, carboxycarbyl, such as polyacetic acid, carboxylatecarbyl, such as acrylates, carbyl, unsaturated carbyl, aryl, and heteroaryl), halocarbyl, organosilane, and organosiloxane, any of which may contain one or more heteroatoms and may contain one or more substituents. The one or more heteroatoms may independently be selected from O, N, S, and Si. In some embodiments, the functional layer compound is selected from substituted or unsubstituted polyether, polyamine or salt of a polyamine, polyacid or salt of a polyacid, polycarboxylate, polyalkane, polyaryl, polysiloxane, polycarbinol, polythiol, polysulfide, polysuphone, polyphosphonate, or combination thereof. Functional layer compounds may be selected from large molecules and macromolecules (e.g., oligomers, polymers, etc.). In some embodiments, at least a portion of the functional layer compound is fluorinated or perfluorinated. In some embodiments, the entire functional layer compound is fluorinated (i.e., the compound is a perfluoro compound).

The functional layer compound comprises at least one reactive group, which may be referred to herein as Rg³. In preferred embodiments, the reactive group is capable of reacting with the second functional group of the coupling compound and forming a chemical linkage between the functional layer compound and the coupling compound. The reactive group of the functional layer compound may, for example, be selected from the reactive groups described above for the coupling compound. Some preferred reactive groups for the functional layer compound are carboxylic acids, hydroxyl groups (including C—OH and Si—OH groups), alkoxy groups (including C—OR and Si—OR groups), epoxy (oxirane), amines, amides, isocyanates and thiols.

In some embodiments, the functional layer compound further comprises at least one functional group. In preferred such embodiments, the functional group is relatively unreactive toward the second type of reactive group of the coupling compound (as compared with the reactivity of the reactive group of the functional layer compound toward the second type of reactive group of the coupling compound). Again, “relatively unreactive” is as defined previously for the coupling compound with respect to the surface exposed reactive groups. In some embodiments, the functional layer compound has one, two, three, or more of the reactive groups. In some embodiments, the functional group(s) and the reactive group(s) of the functional layer compound are the same group(s). In some such embodiments, in the methods of the invention, it will be typical for one or more of such groups to react with the coupling compound and for one or more of such groups to remain unreacted. In some embodiments, the functional group of the functional layer compound is selected from substituted or unsubstituted hydrocarbon, halocarbon (including fluorocarbon and perfluorocarbon) ether, haloether (including fluoroether, and perfluoroether), ester, carboxylic acid, sulphonic acid, phosphonic acid, amine, amide, carbinol, aromatic, organosilane, fluorinated organosilane, and organosiloxane and fluorinated organosilane. In some embodiments, the functional group of the functional layer compound is selected from substituted or unsubstituted perfluorocarbon, perfluoroether, organosilane, organosiloxane, fluorinated organosilane, and fluorinated organosiloxane.

For example, the functional layer compound may have the structure of formula (II)

(Rg³)ₚ-Fn (II)

wherein Rg³ represents a reactive group, p is an integer greater than 0, and Fn represents a functional group. The functional group Fn generally comprises a chain (backbone) moiety that comprises one or more functional moieties. In preferred embodiments, Fn is selected from the hydrocarbyl moieties C₁-C₂₄ alkyl (including C₁-C₁₈ alkyl, further including C₁-C₁₂ alkyl, and further including C₁-C₆ alkyl), C₂-C₂₄ alkenyl (including C₂-C₁₈ alkenyl, further including C₂-C₁₂ alkenyl, and further including C₂-C₆ alkenyl), C₂-C₂₄ alkynyl (including C₂-C₁₈ alkynyl, further including C₂-C₁₂ alkynyl, and further including C₂-C₆ alkynyl), C₅-C₃₀ aryl (including C₅-C₂₀ aryl, and further including C₅-C₁₂ aryl), and C₆-C₃₀ aralkyl (including C₆-C₂₀ aralkyl, and further including C₆-C₁₂ aralkyl), any of which may contain a single or multiple heteroatoms such as O, N, S, Si, or P. Examples of functional moieties suitable for Fn includes groups such as halo, hydroxy, carbinol, carboxy, phosphonic, sulfonic, carboxylate, amino, amido, nitrile, thio and other groups as described below. Furthermore, any of these Fn moieties may be halogenated, including perhalogenated such as perfluorinated or perchlorinated, such that Fn is a halocarbyl moiety. The Fn moieties can be a silicon based chain such as siloxane, silazane, or carbosilane. In some embodiments, the functional group Fn is selected from substituted or unsubstituted hydrocarbon, halocarbon, ether, haloether, estercarbinol, aromatic, organosilane (e.g., organosiloxane, fluorinated organosiloxane, organosiloxazane, organosilazane), and polymeric versions thereof (e.g., polyether, polyfluoroether, polyaromatic, polyorganosilane, fluorinated polyorganosilane, etc.) and may also include any of the following moieties: amide, amine, acidic groups (e.g., carboxylic, sulfonic, phosphonic), basic groups (e.g., amino), organometallic, halo, carbonate, urethane, anhydride, epoxy, oxime, vinyl, acrylate, metacrylate, cyanate, isocyanate, thiocyanate, isothiocyanate, hydroxyl, thiol, disulphide, carboxylic acid, hydrosilane, hydroxysilane, carboxysilane, enoxysilane, epoxysilane, alkoxysilane, vinylsilane and aminosilane.

The ranges of atoms constituting the Fn chains provided above are not meant to be limiting, and in some preferred embodiments, Fn is a large molecule, macromolecule, or polymeric moiety. For example, in some embodiments, the molecular weight of the Fn group is greater than 300 D, or greater than 500 D, or greater than 750 D, or greater than 1000 D, or greater than 1250 D, or greater than 1500 D, or greater than 2000 D, or greater than 3000 D. In some embodiments, the molecular weight of the Fn group is in the range 300-3000 D, or in the range of 500-2500 D, or in the range of 750-1500 D. In some embodiments, the molecular weight of the Fn group is less than 10000 D, or less than 5000 D, or less than 2000 D, or less than 1000 D, or less than 500 D. Where Fn represents a polymeric moiety, the number of repeat units in the polymer may be greater than 10, or greater than 25, or greater than 50, or greater than 100. Any combination (minimum and maximum) of these ranges and values may also be used in the invention.

In some embodiments, the functional layer compound comprises one or more reactive groups and a functional group comprising a chain (backbone) that comprises at least 12, or at least 16, or at least 20, or at least 24, or at least 30, or at least 36, or at least 40 atoms. Again, such atoms may be any combination of carbon atoms and heteroatoms such as O, N, S, Si, or P. The chain may be fluorinated carbon (or otherwise halogenated), perfluorinated carbon, fluorinated ether, or perfluorinated ether (or otherwise perhalogenated). The chain may be silicon based including fluorinated and unfluorinated siloxane, silazane, and carbosilane units. In some embodiments, the chain comprises heteroatoms such as a polyether or polyester structure (i.e., repeating carbon and oxygen moieties), a polyamine or a polyamide (i.e., repeating carbon and nitrogen moieties). In some embodiments, the carbon chain comprises a polyacrylic acid structure. In formula (II) above, Fn comprises the one or more functional groups as well as the chain structures just described.

For example, the functional layer compound may be a perfluorinated C₈-C₄₀ alkyl or a perfluoroether chain of 6 to 60 atoms moieties, further comprising a reactive group for reaction with the coupling compound. Such moieties may be branched or unbranched, may be further substituted as desired, and may contain one or more heteroatoms in the alkyl chain.

As with the coupling compound, in some embodiments, the functional layer compound is a polyfunctional compound. For example, the functional layer compound may be an oligomer or polymer comprising monomer units each having a reactive group or a functional group. In other embodiments, the functional layer compound is an oligomer or polymer having a single reactive group at one end of the backbone of the functional layer compound, or two reactive groups (one at each end of the backbone of the functional layer compound, i.e., a telechelic polymer/oligomer). In some embodiments, the functional layer compound comprises a polymeric backbone comprising multiple monomeric units, some or each of which contain the functional group. It will be appreciated that one or more of the monomeric units also or alternatively comprises the reactive group. In some embodiments, the functional layer compound comprises a polymeric backbone comprising carbon and optionally comprising one or more heteroatoms, and wherein the functional layer compound is fluorinated, perfluorinated, silylated, hydroxylated, aminated, or any combination thereof. Examples of suitable polymers include polysiloxanes, polysilazanes, polyethers, polyamides, polyesters, polyacids, polyaminoacids, peptides, polynucleic acids, and copolymers thereof.

Specific examples of suitable functional layer compounds include perfluoro carbon, perfluoroether, siloxane, polyamine, polyethers, polycarboxylic acid, polyol, polyaromatic, and polyheteroaromatic chains that possess one, two, or more reactive groups, preferably at terminal sites that can react with the free reactive group of the surface bonded coupling compound. Some specific examples of suitable functional layer compounds are given in the examples provided herein, and include perfluorodecylcarboxylic acid, perfluorooctylamine, perfluorooctylcarboxylic acid, perfluorinated polyethylenoxide (e.g., FLUOROLINK® C, C10, D, D10L, L or L10), polydimethysiloxane (PDMS), polyhydridomethylsilane (PHMS) and derivatives thereof (such as PHMS-OH, which is PHMS that has undergone a dehydrocoupling reaction to replace some or all of the hydrido groups with hydroxyl groups), perfluorinated alkyl silanes and siloxanes such as perfluorinated decyltriethyoxysilane, and allylperfluoro-octyl-PHMS-OH.

Mixtures of functional layer compounds may be used in the methods of the invention. Such mixtures include binary, ternary, and quaternary mixtures.

The functional layer compound may be selected such that it imparts specific properties to the substrate surface. For example, if an oleophobic/lipophobic surface is desired, one approach to obtaining such a surface is to provide a functional layer compound with oleophobic/lipophobic properties, such as a fluorinated hydrocarbon or perfluorinated carbon functional layer compound. Similarly, hydrophobic coatings can be created using, for example, non-polar functional layer compounds such as polysiloxanes and halogenated hydrocarbons. Similarly, oleophilic/lipophilic coatings can be prepared using, for example, functional layer compounds comprising hydrocarbon moieties. Similarly, hydrophilic coatings can be created using, for example, polar functional layer compounds such as polyhydroxy compounds or polyethers.

The functional layer compound possesses one, two, or more reactive groups, preferably at terminal sites, that preferentially and selectively react with the free reactive group of the coupling compound already bonded to the substrate. Preferably these reactive groups on the functional layer compound do not react with each other, although the products of such self-condensation reactions can typically be removed (or are still further capable of reacting with the free reactive groups of the coupling compound), and do not interfere with the final performance of the coatings.

As described previously, the functional layer compound comprises one or more reactive groups and may comprise one or more functional groups. In the case of functional layer compounds having multiple reactive groups, such reactive groups should not be dominant—i.e., they should not significantly adversely affect the desired functionality of the overall surface coatings by forming the interface between the bonded functional coatings and the environment. An exception is wherein the functional group is the same or similar to the reactive groups as for examples in the cases of polyamines, polyacrylic acid, and polycarbinols. For large or macromolecular functional layer compounds, the functional groups can be hidden in the brush like coatings by being folded back from the surface.

Further examples of the reactive groups and/or functional groups suitable for the functional layer compounds include protected or unprotected amino, epoxy, isocyanate, carboxylic, ester, vinyl, halo, halo-silane, hydro-silane, imine, carbonate, urethane, anhydride, oxime, acrylate, metacrylate, cyanate, thiocyanate, isothiocyanate, hydroxyl, thiol, disulphide, hydroxysilane, carboxysilane, enoxysilane, epoxysilane, alkoxysilane, vinylsilane and aminosilane, hydroxyl (including C—OH and Si—OH as well as polyhydroxyl groups such as —Si(OH)ₙ, where n is 1 to 3), sulfhydryl, C₁-C₂₄ alkoxy (including C—OR, O═C—OR and Si—OR as well as polyalkoxy groups such as —Si(OR)ₙ, where n is 1 to 3 and R is alkyl), C₅-C₂₀ aryloxy (including C—OR and Si—OR as well as polyaryloxy groups such as —Si(OR)ₙ, where n is 1 to 3 and R is aryl), mixed aryloxy/alkoxy groups (such as —Si(OR)ₙ, where n is 1 to 3 and at least one R is aryl and at least one R is alkyl), acyl (including C₂-C₂₄ alkylcarbonyl and C₆-C₂₀ arylcarbonyl), acyloxy, C₂-C₂₄ alkoxycarbonyl, C₆-C₂₀ aryloxycarbonyl, halocarbonyl, C₂-C₂₄ alkylcarbonato, C₆-C₂₀ arylcarbonato, carboxy, carboxylato, carbamoyl, mono-substituted C₁-C₂₄ alkylcarbamoyl, di-substituted alkylcarbamoyl, mono-substituted arylcarbamoyl, thiocarbamoyl, carbamido, cyano, isocyano, cyanato, isocyanato, isothiocyanato, azido, formyl, thioformyl, thiol, amino, mono- and di-(C₁-C₂₄ alkyl)-substituted amino, mono- and di-(C₅-C₂₀ aryl)-substituted amino, C₂-C₂₄ alkylamido, C5-C20 arylamido, imino, alkylimino, arylimino, nitro, nitroso, sulfo, sulfonato, C₁-C₂₄ alkylsulfanyl, arylsulfanyl, C₁-C₂₄ alkylsulfinyl, C₅-C₂₀ arylsulfinyl, C₁-C₂₄ alkylsulfonyl, C₅-C₂₀ arylsulfonyl, phosphono, phosphonato, phosphinato, phospho, and phosphino, mono- and di-(C₁-C₂₄ alkyl)-substituted phosphino, mono- and di-(C₅-C₂₀ aryl)-substituted phosphino. In some embodiments, multiple different reactive groups are present on the functional layer compound, wherein the first reactive group is capable of forming a chemical linkage with substrate surfaces that do not have reactive groups, such as the thiol/gold example mentioned previously. Other useful reactive groups are SiXₙ, where X is halo (Cl, F, Br or I) which can directly react with M-OH groups at the surface. X can be O₂CR″ or NR″R′″ wherein R″ is, low alkyl or organo silyl and R′″ is H, low alkyl or organo silyl. In the case of Si—OR, SiO₂CR″ and SiNR″R′″ (i.e., protected reactive groups), a small level of water is required to partially hydrolyze the protecting groups and allow easier bonding to the substrate. Excessive amount of water is not desire since uncontrolled hydrolysis and formation of Si—OH can lead to undesired self condensation reactions of the coupling compounds themselves.

Additional examples of reactive groups are groups that chemically react with the groups mentioned above, i.e., groups that react with the functional group of the coupling compound.

The reactions between the reactive groups on the coupling compound bonded to the surface and the functional layer compound may, in some embodiments, be carried out in the presence of a catalyst (also referred to as a reaction catalyst or an activation catalyst). As will be appreciated, the identity of the catalyst (e.g., acid, base, transition metal complex, etc.) will depend on the type of reaction that occurs between the functional layer compound and the coupling compound. Typically such reactions are based on model reactions that are known in the pertinent literature. Furthermore, the reactions between the reactive groups on the coupling compound bonded to the surface and the functional layer compound may, in some embodiments, produce side products such as small molecules (e.g., water, alcohols, etc.). Such side products are, in most cases, removed by standard purification methods. Such methods include washing the surface with an appropriate solvent, subjecting the surface to reduced pressure, submersion in a washing solvent, and the like. Such side products may be removed separately or at the same time when excessive amount of the functional compound is thoroughly removed.

A preferred method for contacting (i.e., reacting) the functional layer compounds with the bonded coupling compound is by immersing and “incubating” the substrate already treated with the coupling agents in a dilute solution of the functional layer compound.

In the methods of the invention, coatings are prepared on substrates. The substrate is provided and prepared according to the methods described herein. For example, the substrate may be cleaned using any appropriate method such as, for example, washing, sonication, and the like, and may further be patterned using any appropriate method such as, for example, lithography and the like.

The substrate may need to be activated by removal of organics or oxidation of the surface using plasma, discharge, oxidizer solutions and gases, acid or base treatments UV or e-beam radiation, or rapid surface heating. Such treatment (also referred to as “pre-treatment”) can expose or increase the number of reactive groups at the surface. In the case of organic substrates, the treatment will oxidize the molecular structure at the surface, making the surface both more wettable as well as capable of reacting with the coupling compound.

The substrate is then exposed to the coupling compound, which may be either dissolved in a solvent or presented to the substrate without any solvent (i.e., neat). The surface exposed reactive groups are contacted with the first reactive group of the coupling compound under conditions effective to allow reaction between the groups. Such conditions will depend upon the identity of the groups, but may involve room temperature or elevated temperatures (e.g., 30° C.-100° C.), atmospheric or reduced pressure, ambient or inert atmosphere, and/or reaction times of between about 30 seconds and about 24 hours, preferably between about 1 min and about 1 hour. Such conditions may further involve the application of energy, such as by sonication, UV radiation, and the like. The method for attaching the coupling compound to the substrate may be accomplished, for example, by leaving the substrate in a solution comprising the coupling compound for a predetermined time, by briefly dipping the substrate in such a solution and allowing the dipped substrate to dry, or by spraying the solution of the liquid coupling compound.

Once the coupling compound has been chemically bonded to the surface, the surface may be cleaned from any unbonded excess of the coupling compound, for example, by solvent washing techniques. In general, the formation of a single monolayer or less of the bonded coupling group is desired. However, multiple layers of the coupling compounds are adequate provided that the layers are covalently bonded to the first monolayer. Such situation is feasible for example in the case of coupling agents having the formula (RO)ₙSi-(Rg)₄₋ₙ wherein RO is either an alkoxy or hydroxyl group capable of undergoing a condensation reaction with another molecule of the coupling compound, and Rg is one of the reactive groups as described previously (e.g., Rg²). Another example is XₙSi-(Rg)₄₋ₙ wherein X is an halide or an amine; such compounds, in the presence of water or surface —OH groups, are vulnerable to hydrolysis reactions forming Si—OH on the coupling compound. Such formation allows condensation with other molecules of the same compound.

In some embodiments, the first and second reactive groups of the coupling compound are the same, although not all of the groups react in the first reaction that bonds the coupling compound to the substrate. For example, the coupling compound may be a tetraalkoxy silane or a diamine compound. In such instances, at least one of the functional groups remains unreacted upon bonding of the coupling compound to the substrate due to steric hindrance, leaving such groups to bond to the functional layer compound.

Substrate with surface-bonded coupling compound is then contacted with the functional layer compound under reaction conditions effective to allow reaction between the second reactive group of the coupling compound with the reactive group of the functional layer compound. Depending on the identity of the reactants, similar reaction conditions as for the attachment of the coupling compound may be used for attachment of the functional layer compound.

In the case wherein there is a strong initial affinity between the free reactive groups of the bonded coupling agent and the reactive group of the functional layer compound, such as obtained by the interactions between carboxylic acid and amine or between opposite charged groups, the excess of the functional coatings compound may be removed at this stage. If this is not the case, then it is necessary to react these groups first and form covalent bonding between the coupling reagent and the functional compound prior to the attempts of washing away the excessive amount of the functional compound.

After the reaction between the second reactive groups of the bonded coupling compound and at least one of the reactive groups of the functional layer compound have been achieved, excess of the functional layer compound can be removed by various washing and cleaning techniques. For many applications it will be important to remove such an excess to achieve the maximal effect and to prevent undesired leaching of unbonded functional layer compound. Also, non-bonded functional compounds can be aligned at the surface with reactive groups undesirably oriented toward the environment and therefore reducing the functional effect.

A curing step may be included in the preparation of the coatings of the invention. Such a curing step may be carried out, for example, in order to complete the linking of either the coupling compound to the substrate or molecules of the functional layer compound to the coupling compound or to one another after attachment to the substrate has been achieved. Curing reactions may be carried out with or without a reaction catalyst, and in some embodiments only heat for a period of time is required for curing. In some embodiments, for example, elevated temperature (e.g., temperatures in the range of 50 to 200° C., such as above 70° C., or above 100° C., or above 120° C.) for a predetermined period of time (e.g., about 10 min, or between about 30 min and 24 hours, or between about 1 and 2 hours) may be applied to carry out the curing. In addition or in the alternative, a reaction catalyst such as a transition metal compound, an acid, or a base may be used to carry out the curing reaction.

As mentioned previously, the coated surfaces prepared according to the invention may exhibit a variety of surface properties. Preferred examples of such properties are hydrophobic, hydrophilic, oleophobic/lipophobic, oleophilic/lipophilic, electropositive or electronegative, bio-inert or bio-reactive, chemical affinity selective, conductive or dielectric. Surfaces with functional coatings prepared according to the invention may be substantially homogeneous, meaning that they are substantially free of defects such as pinholes and cracks, although in many cases desirable surface properties can be obtained even with the presence of surface defects in the coatings. Coating thicknesses may be substantially uniform (varying, for example, by less than 25%, or by less than 15%, or by less than 10%, or by less than 5%, or by less than 1%). Coating thicknesses (measured including both functional layer compound and coupling compound) will vary depending on a number of factors, such as the identity of the coating and coupling compounds and the intended use, but may range from less than 1 nm to about 10 μm or between about 2 nm and about 1 μm, or between about 1 nm and about 100 nm. In some preferred embodiments, the coating layers are less than 1 μm in thickness, or less than 0.5 μm, or less than 0.25 μm, or less than 100 nm, or less than 50 nm, or less than 20 nm, or less than 10 nm, or less than 5 nm, or less than 1 nm.

Surface defects can be minimized, for example, by using thicker coatings and/or multiple coating layers. In one embodiment, surface defects are minimized by using additional functional layer compound similar to, or different from, the first functional compound. Such additional functional layer compound is reacted with the previous (i.e., first) layer of functional layer compound in the same manner as the first layer is reacted with the bonded coupling compound. In this case, free reactive groups of the bonded functional layer compound will be chemically reacted with reactive group of the additional layer of a functional layer compound to form covalent bonding.

Smudge resistance functional coatings can be created using the methods of the invention. A common source of smudges is human skin, and smudges commonly contain compounds found on human fingers, ears, cheeks and other regions of skin, as well as in fingerprints and earprints. Such compounds are commonly found on the displays of electronic devices such as mobile phones and computers, kitchen appliances and furniture, car dashboards and more and are the result of normal and expected use of such devices. The presence of such compounds on displays can cause fuzzy or distorted images if deposited on a transparent surface or can cause the surface to be conceived as a dirty surface even when deposited on non-transparent surface. Modern displays and similar surfaces commonly suffer from such distortions after minimal use of the devices.

Aside the visual aspect, such kind of persistent staining due to fingerprints and other body oil depositions can chemically enhance corrosion effects. Such corrosion can lead to permanent staining of the material (e.g., steel, glass). It can also causes interruption of optoelectronic device performance. It can cause skin allergies as in the case of nickel electroplated jewelry. In biomedical applications such stains can result in bacterial or fungi contaminations.

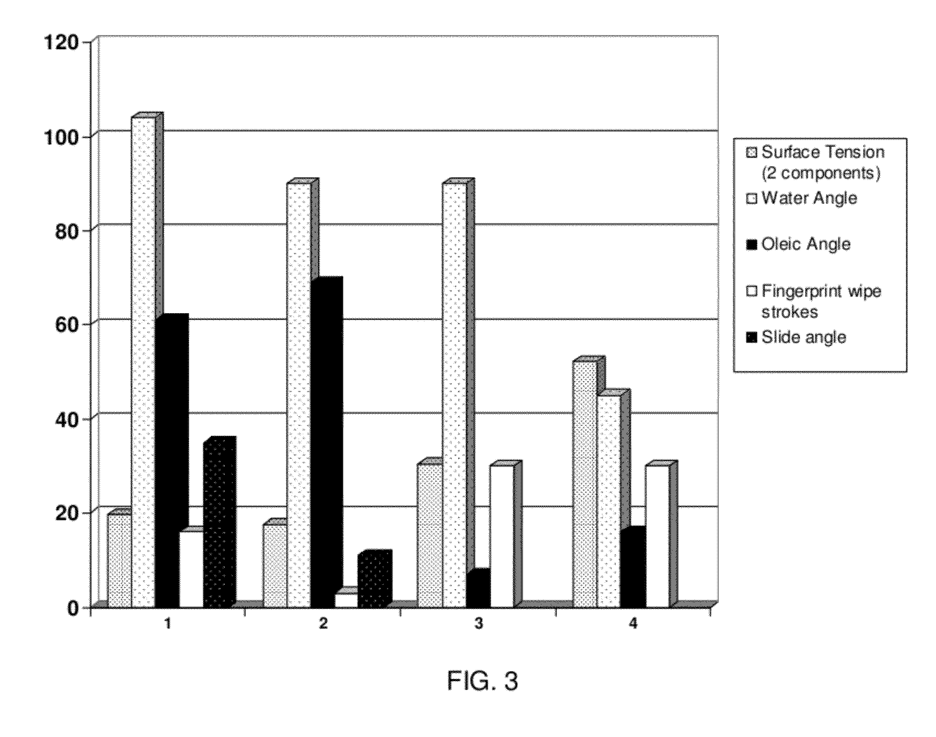

Body oils and especially fingerprints are composed of a complex mix of fatty acids, fatty acid monoesters (waxes), triglycerides, squalene, salts and water. Water perspiration is the carrier of these oils and wax compositions through the skin and their deposition at the surface of objects that come in contact with the skin. Therefore, it is commonly conceived that the smudge resistance and easy clean of such body-generated stains are associated with the hydrophobicity of the surface, which is associated with a generic low surface tension, i.e., the lower the surface tension and the higher the contact angle with water droplets—the better smudge resistance and easy removal characteristics. For these reasons, perfluoro-carbon functional compounds and polymers and organo silanes and siloxanes are typically considered as the best candidates for smudge resistance and easy-clean surface treatments. Nevertheless, this invention shows that an important feature associated with the removal of natural fingerprint or an artificial composition representative of fingerprint residue (such as sebum) is, in fact, the oleophobicity of the surface. Thus, surface treatments with higher oleophobic characteristics are preferred, with oleophobic characteristics conveniently indicated by: (a) highest contact angles for oil droplets (oleic acid was used as representative) and high boiling point hydrocarbon solvents (such as octane); and (b) smallest sliding angle required to start moving a droplet of oil at a treated surface. Examples for such correlations are presented in FIG. 3. Accordingly, in preferred embodiments of the invention, smudge resistant and easy-clean surfaces are prepared by providing an ultra-thin (e.g., monolayer), chemically bonded layer that imparts high oleophobicity to the underlying substrate.

In addition to the overall low surface tension, it is important to associate chemical affinity of the compound or formulation with the surface chemistry. In that regard, the “2 component model” used for computing surface tension of substrates is more indicative than the “1 component model”, since it provides both “polar” and the “non-polar” components the are summed up to give the overall surface tension. Both the one- and two-component models are based on empirical mathematical formulations that do not take into account chemical affinity aspects. Both model calculations are based on measuring a series of contact angles of liquid droplets with known surface tension values. We noticed that most of the commercial and scientific values given to material surfaces are based on the one component model which is simpler to use. We also realized the one component model gives lower values than the two component model. However, the second method can be much more correlated to the oleophobic characteristics required for enhancing smudge resistance. Lowering the values of the 2 component model to below 20 dyne/cm and more preferably below 18 dyne/cm was found to be important. Lowering the polar component of the model to below 6 dyne/cm and further below 4 dyne/cm and furthermore below 2 dyne/cm was found to be important to achieve high values of oleophobicity which is required to resist smudge and provide for easy cleaning. Perfluoro-carbon treatment of surfaces has demonstrated very low values of the polar component. However, long chain perfluoroethers (polymers) linked chemically to the surface outperformed the perfluorocarbons, indicating that they have lower affinity to organic oils. Especially, the use of perfluoroethyleneoxide (FLUOROLINK® type products) have demonstrated the best results thus far, exceeding surfaces consisting of perfluorocarbons like polytetrafluoroethylene (Teflon).

Aside from the preferred surface tension and chemical affinity characteristics, the strong bonding of the smudge resistance treatment to the substrate is highly critical (along with high clarity in the case of transparent substrates) to render the characteristics of treatment durable for prolonged time of usage. Therefore, the process in the invention is highly useful to achieving durability by: (a) insuring chemical bonding to the surface; (b) limiting the functional compound (including polymeric species) to a monolayer, if desired; and (c) maintaining complete transparency of the material, if necessary.

The processes demonstration herein, in conjunction with the generation of both highly oleophobic and oleophilic treatments, is advantageous over previous approaches where the functional compound is first bonded to the reactive group intended to bond to the substrate. Typical examples are functional compounds and polymers having alkoxy or chlorosilane terminal site or sites). Such reagents are currently commercially available and are processed by dipping the substrate into dilute solution, preferably by processes associated with Langmuir-Blodgett deposition techniques that are very delicate and time consuming, limiting the size, expanding the required space, and increase the cost of manufacturing such functional treatments.

In addition, for previous approaches using functional compounds already bonded to one reactive group, obtaining orientation in a way that the reactive groups are solely directed to, and interact with, the surface is unlikely even when Langmuir Blodgett processing is used. Thus, occasional orientation with reactive groups that, instead of bonding to the surface, are oriented with “head” facing the surrounding environment will occur statistically, reducing both the bonding durability to the surface and the maximum intensity of the functionality. In the case of a polymeric functional compound this situation will be more pronounced, and in the case of a polymeric compound having two terminal sites with reactive groups the occurrence will be very high. Such reactive groups for bonding to the substrate are commonly alkoxy, hydroxy, chlorosilanes, phosphates, or phosphites, and if they are facing the outer side of the film they can diminish the desired functionality. This situation is substantially or entirely avoided in the processes described in this invention, since the reactive groups to be bonded to the substrate are not pre-bonded to the functional compound. In some embodiments of the invention disclosed herein, the functional compound or polymer has only one reactive site capable of reacting with a reactive group of the coupling agent already bonded to the substrate. In other embodiments, the functional compound or polymer has more than one functional group. In such embodiments, each of the plurality of functional groups may bond to the surface, and if one (or more) functional group does not bond to the surface its negative effect is expected to be significantly milder than in the case of defects in previous methods (e.g., misaligned reagents). Furthermore, any excess of unbonded functional compound is removed by sonication in solvent.

Complete or even partial removal of the smudges is often difficult, and requires the use of specialized cleaning cloths and/or solutions. In some embodiments, the coatings of the invention provide a smudge resistant surface, which includes surfaces that resist significant deposition of smudge-related compounds as well as surfaces that are relatively easily and/or completely cleaned of such compounds due to the lack of affinity between the smudge composition and the functional coating bonded to the surface.

Quantification of the smudge-resistant properties of the coatings of the invention may involve any convenient measure, but are typically carried out by comparing the properties of a coated surface with the properties of an uncoated surface under substantially similar conditions (i.e., same weight, material, and distribution of smudge, same material and amount of force used to remove the smudge, etc.). For example, compared with a bare surface (i.e., not containing a coating according to the invention) under equivalent conditions, surfaces containing a coating according to the invention require fewer wipes with a cloth to substantially remove a smudge (e.g., reduce the haziness or visualness of the smudge by at least 90%, or by at least 95%, or by at least 99%). As another example, compared with a non-coated surface, each wipe with a cloth removes a greater weight percentage of a smudge from a surface containing a coating according to the invention (e.g., each wipe with a cloth removes at least 90% of the haziness or visualness of a smudge, or at least 95%, or at least 99%). Because the comparisons are carried out under substantially similar conditions, such methods for quantifying the properties of the surface coatings are not dependent upon the type of smudge, the type of cloth, the method of wiping or other such variables.

According to this disclosure, then, there is provided a method for forming a coating on a substrate, the method comprising: (i) a first step of forming a first layer of a coupling compound at a surface of the substrate by contacting the surface with the coupling compound, wherein the coupling compound has at least one of a first reactive group that is capable of forming a covalent bond with the surface and at least one of a second reactive group (as described elsewhere herein, the first reactive group and the second reactive group may be the same, or may be different, and in the latter case the second reactive group is relatively non-reactive with the surface); and (ii) a second step of forming a functional coating layer by reacting the second reactive group of the coupling compound with a functional layer compound comprising at least one reactive group capable of forming a covalent bond with the second reactive group of the coupling compound. In some embodiments, the first layer is a monolayer. In other embodiments, the first layer is not a monolayer—i.e., the first layer is a multilayer. In some embodiments, the functional layer is oleophobic, oleophilic, hydrophobic, hydrophilic, electrostatic, sorbing, electroresponsive, charge responsive, catalytic, bioinert, bioactive, or a combination thereof. In some embodiments, the functional layers are smudge resistant, easy clean, or both.

As described herein, certain process conditions may be employed in the methods of the invention. For example, in some embodiments, the first step (i.e., reaction of the coupling compound with the surface exposed reactive groups) is performed in solution—i.e., by submersing the substrate in a solution container containing a solution of the coupling compound. In some embodiments, the second step (i.e., reaction of the functional layer compound with the coupling compound) is performed in solution—i.e., by submersing the substrate in a solution container containing a solution of the functional layer compound. In some embodiments, both first and second steps are performed in solution. In some embodiments, excess coupling compound (i.e., non-bound to the surface) is washed away or otherwise removed after the first step. In some embodiments, excess functional layer compound is washed away or otherwise removed after the first step. In some embodiments, the method further comprises assisting at least one of the first step and the second step by sonication. In some embodiments, the first step and the second step are performed in an environment independently selected from a vacuum, an inert environment, and air. In some embodiments, the method (i.e., steps one and two) is carried out below 150° C., or below 125° C., or below 100° C.

There is a strong correlation between smudge resistant properties and high degree of oleophobicity. The attribute of the oleophobicity of the surface was found to be more important than the surface being hydrophobic or having low surface tension. For instance, low surface tension treatments that are also oleophilic such as many olefinic and vinyl based polymers are highly hydrophobic in their nature. Yet, they were found to attract smudges and were hard to clean. Perfluoro carbons that have high hydrophobicity and low surface tension were found to cause better adherence of fingerprints compared with the best oleophobic surfaces. Perfluoroethers were found to be even better in their smudge resistance and easy clean characteristics.

The methods of the invention involve a two-step process for forming a functional layer covalently attached to a substrate. The methods have numerous advantages over one-step processes (whereby a functionalized coating compound comprising a coupling moiety is directly reacted with a substrate, thereby forming the bonding directly, such as demonstrated in Sample 85 in the Examples provided herein infra) and methods that do not involve covalent attachment. Such advantages may include, without limitation: an improved ability to form a monolayer or sub-monolayer of the functionalized layer compound; an improved ability to form a uniform and oriented and self-assembled dense layer; an improved ability to form a robust surface layer chemically bonded to substrate; an improved ability to avoid arrangement of the functional coating with the coupling moiety facing the environment side rather than the substrate side, and combinations thereof. A further advantage of the methods described herein is the transparency of the coatings. Because the methods of the invention provide a monolayer of the functional layer compound, the coatings of the invention are substantially or completely transparent and are substantially or completely free of optical distortions (i.e., no refractive or reflective effects). A further advantage of the methods described herein is the ability to “scale up” (i.e., perform the methods on a larger scale, such as for large surfaces, e.g., greater than 1 in², or greater than 1 ft², or greater than 1 m²) at relatively low cost. For example, scale-up of self-assembled functional monolayers by Langmuir Blodgett methods of preparing coatings is very expensive and very time-consuming, whereas scale-up of the methods of the invention is relatively quick and inexpensive.

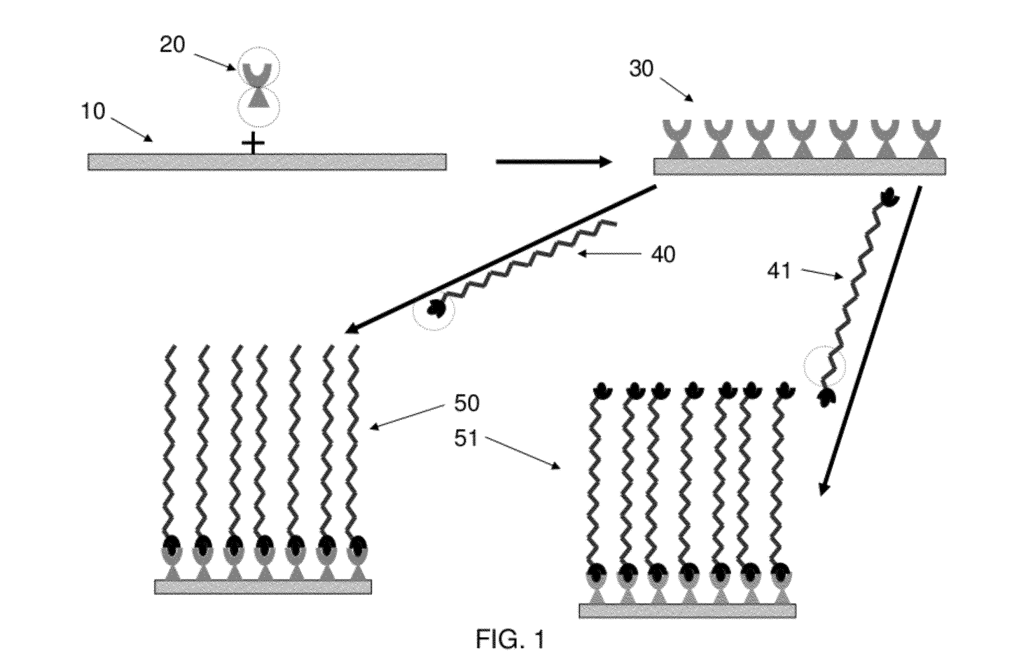

With reference to FIG. 1, there is provided a schematic of a generalized embodiment within the scope of the invention. A substrate 10 and a coupling compound 20 are reacted (e.g., in solution) to form a substrate having a first layer 30 comprising a monolayer of coupling compound chemically bonded thereto (although not shown in FIG. 1, as mentioned herein it will be appreciated that layers greater than a monolayer, such as bilayers, etc., are also within the scope of the invention). Coupling compound 20 has a first reactive group that is depicted in FIG. 1 as a triangle. It will be appreciated that the first reactive group of the coupling compound reacts with surface exposed reactive groups on the substrate surface, although the latter are not shown in the figure. Coupling compound 20 has a second reactive group that is depicted as a horseshoe and is exposed as the monolayer surface. Next, the coated substrate is exposed to, and reacted with, functional layer compound 40 or 41. Functional layer compound 40 has a single reactive group, depicted by two half circles, at one terminus of the compound. Functional layer compound 41 has two such reactive groups—one group at each terminus of the compound. The reactive group of the functional layer compound is complementary to the second reactive group of the coupling compound, but generally, the reactive group of the functional layer compound is not reactive with itself under the reaction conditions (i.e., with another identical group from a different functional layer compound). Reaction of the reactive groups of the functional layer compound and the coupling compound leads to the formation of coated substrates 50 and 51. Generally, for coated substrate 51, the unreacted terminal group on the functional layer compound does not have much effect on the functional characteristics such as surface tension of the surface, since the group tends to form hydrogen bonds with another identical group or the group adopts a configuration such that it is not exposed at the surface (e.g., by being tucked under the long-chain portion of the functional layer compound). The second functional group may also react with another reactive group of a coupling compound forming a “bow” structure (i.e., one functional layer compound bonded at two different sites at the surface). The functional aspect of the resulting surfaces is derived from the exposed portion of the functional layer compound. The process reinsures that only a monolayer of the functional group will be deposited. Excess of the functional compound that is not chemically bonded can be removed from the surface by washing or wiping techniques.

In a specific example of the embodiment shown in FIG. 1, coupling compound 20 is RₓSiX₃, wherein X is alkoxy group such as ethoxy and Rₓ is another reactive group such as an epoxy or an amine, substrate 10 is glass having exposed —OH groups, and monolayer 30 is formed by reacting the exposed —OH groups with the hydrolyzed (deprotected) SiX₃ portion of coupling compound 20. Functional layer compound 40 is R_{f}-R_{y}, wherein R_{f} is a fluoropolyalkyl or fluoropolyether moiety and R_{y} is selected such that Rₓ and R_{y} can react but R_{y} cannot react with another R_{y}. Specific examples for R_{y} are carboxylic or ester groups. The resulting coated substrate 50 has exposed a monolayer of R_{f} moieties, which determine the surface properties (oleophobicity, hydrophobicity, etc.) of the substrate.

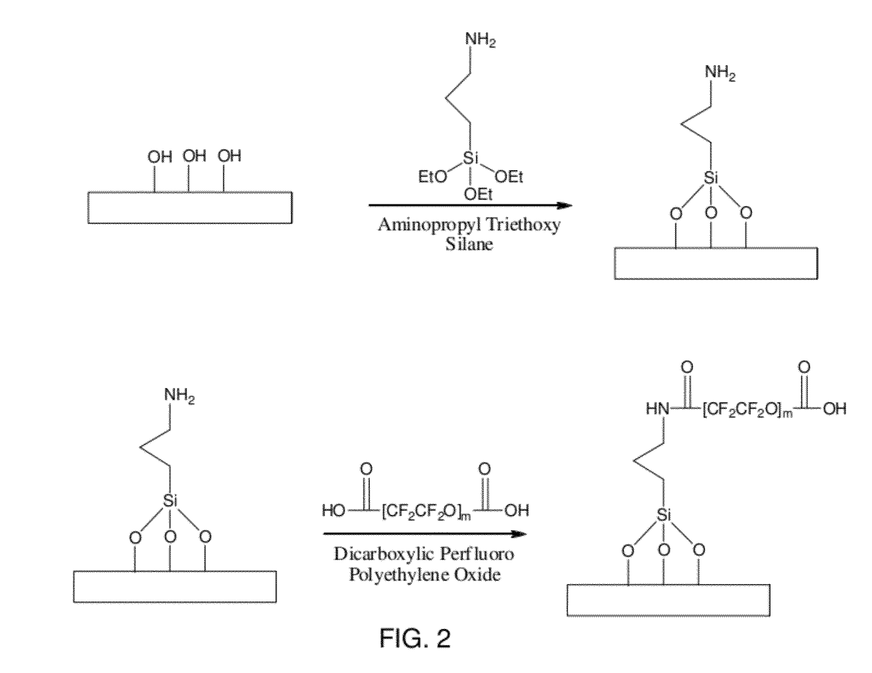

With reference to FIG. 2, there is provided a schematic of an embodiment within the scope of the invention. A substrate having exposed reactive —OH groups is reacted with aminopropyl triethoxy silane (e.g., in solution) to form a substrate with a first layer—i.e., a monolayer coating of a coupling compound having exposed amino groups. The coated substrate is then reacted with dicarboxylic perfluoro polyethylene oxide (e.g., in solution) to form a substrate with a first layer and a second layer—i.e., a second layer comprising fluorinated functional groups.

With reference to FIG. 3, data from four samples are provided to illustrate the properties of the layers of the invention. Sample 1 is a substrate having a commercially-available perfluoro-polycarbon-chlorosilane (specifically, sample 87 in Example 5 below), which is known to provide very low surface tension and high degree of hydrophobicity. Sample 2 is a substrate having a coating prepared according to one embodiment of the invention (specifically, sample 18 in Example 5 below), which provides very low surface tension and presents high oleophobicity and hydrophobicity. Sample 3 is a substrate having a coating prepared according to one embodiment of the invention (specifically, sample 21 in Example 5 below), wherein the functional layer is hydrophobic but simultaneously oleophilic, as well. Sample 4 is an untreated glass slide. Five data points are provided for each sample—surface tension (measured using the “2-component method”), water contact angle, oleic acid contact angle, number of wipe strokes required to remove a fingerprint, and slide angle, which is the tilting angle from an horizontal position requiring to start the sliding of the droplet down the tilted surface. See the Examples section below for general explanations and procedures in obtaining these data points. As can be seen from the data, easier cleaning of fingerprints is obtained when the surface tension values are low. Furthermore, oleophobic characteristics are very important, and in fact are more important than hydrophobic behavior for determining ease of fingerprint cleaning. The data shows that there is a direct correlation between the oleophobicity and ease of fingerprint removal. For samples with a higher contact angle of oil (oleic acid), a lower angle is required to slide down the droplet. Furthermore, the ease of cleaning fingerprints is not necessarily indicated by surface tension and contact angle values of water. In fact, there is no direct relationship between hydrophobicity (water contact angles) and the ease of removing fingerprints. Super-hydrophobic surfaces did not perform well with respect to ease of cleaning once an oil droplet has been smeared at the surface. Highly oleophobic surfaces are prepared, as demonstrated in the Examples and described herein, using compounds such as FLUOROLINK C® (i.e., perfluoro-polyethelene ether of molecular weight ranging from 1000 to 2000D),).

All patents, patent applications, and publications mentioned herein are hereby incorporated by reference in their entireties. However, where a patent, patent application, or publication containing express definitions is incorporated by reference, those express definitions should be understood to apply to the incorporated patent, patent application, or publication in which they are found, and not to the remainder of the text of this application, in particular the claims of this application.

It is to be understood that while the invention has been described in conjunction with the preferred specific embodiments thereof, that the foregoing description as well as the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains.

### EXAMPLES

### Smudge and Fingerprint Cleaning

### General Procedures

Smudge deposition method. An artificial sebum formulation was generated based on typical representative of organic compounds, oils and waxes found in fingerprints and other body oils. The mixed components took into consideration commercial availability and cost of the mixed compounds. The following table details the artificial fingerprint composition.

| Composition | Weight % |
|---|---|
| squalene, 97% | 10.60 |
| lanolin (wax esters) | 25.00 |
| triglyceride | 33.00 |
| oleic acid, 99% | 11.32 |
| stearic acid, 99+% | 5.66 |
| lauric acid, 99% | 11.32 |
| cholesteryl oleyl carbonate | 2.00 |
| cholesterol, 99+% | 4.00 |

A small amount of artificial sebum formulation was deposited at the flat surface of a rubber lab stopper (diameter=2.1 cm) and excess was removed away by blading with a glass slide to provide an even smeared layer of the sebum ointment. The artificial sebum is then stamped in the middle of a glass slide. The estimated weight forced by the finger is 2.5 kg. The process was repeated on 4 different slides with different amounts of deposited smudge, in order to eliminate the effect of how much material has to be removed. The weight of the smudge is in the range of 0.1 to 1.0 mg.

Finger print deposition method. Hands were put in rubber gloves for 10 min. Then a slide was fingerprinted with substantial force by three different fingers immediately after the glove has been removed. The estimated weight forced by the finger was 2.5 kg. The weight of the fingerprints was found to be less than 0.01 mg and could not be measured. The cleaning procedure in this case was immediately performed by the 12.5 cm back and forth motion of a cloth or a paper tissue under constant weight, as indicated by the procedure below.

Wiping procedure. A 20×20 cm wiping cloth (SPI supplies; Microfiber Cleaning Cloths #5149Y) was stapled under tension on a wood board. The smudged or fingerprinted slide was put upside down (soiled area is faced down) in parallel to the square shape at one side the stapled cloth. A cylindrical weight of 300 g (diameter=3.1 cm; height=4.1 cm) was placed on top of the smudged area. The 300 g weigh was selected after testing the force various people put at the surface of a glass when they attempt to wipe off smudges with a cloth. The slide's 4 corners were then touched from the side (about 30° angle) by the thumb and the index finger of each hand. The slide was dragged back and forth across the pad for a distance of 12.5 cm each stroke until no more haze was visually observed. (The haze observation was performed by tilting back and forth the slide against a black background.) The total counts of strokes needed to eliminate the visual smudge were recorded.

Modified wiping procedure. In order to deal with wiping directions issues, the wiping technique has been modified to allow rotating the slide 90° after each stroke. Samples that were tested before the revision are marked in the tables (e.g., with a star). Other modifications to the test procedure were the use of different cloths and paper tissues and applying different weights.

Abbreviations used in the examples that follow: aminopropyltriethyoxysilane (APTES); glycydyloxypropyltrimethoxysilane (GPMS); FLUOROLINK® (FL)—a commercial series of perfluoro polyethyleneoxide terminated with reactive groups produced by SOLEXIS®; perfluorinated (PF).

The following examples provide evidence for the advantage of forming robust functional surfaces in which the functional coating is covalently bonded to the substrate surface, is formed as a monolayer of the long compound or polymer, and no coupling agent groups are found at the interface between the coating and air. The surface treatment described in this invention is compared to conventional treatments with similar commercial fluoro reagents that are used for preparing surfaces that possess very low surface tension and high hydrophobicity. The improved oleophobicity and robustness of this invention is demonstrated for smudge resistance applications over transparent glass substrate. Also demonstrated is the capability to use the technique for obtaining other surface properties by altering the functional layer compound. The formation of Oleophilic, yet hydrophobic, surface is also described (e.g., sample 21).

### Example 1

### Procedure for Depositing Functional Coatings on Glass Slides

The procedure used for depositing smudge resistance functional coatings (e.g., sample 18 described below) is shown in FIG. 2 and is described in the following paragraphs.

Cleaning: Glass slides were pretreated with 20% HCl/EtOH solution, followed by a wash in pure EtOH and pure acetone. The slides were dried in vacuum oven at 60° C. overnight.

Step 1: Surface reacted with coupling compound—APTES. Slides were dipped into 2% APTES solution in 95% EtOH for 10 minutes while sonicating. Afterward, slides were washed with EtOH (95%) by sonication for 1 minute, and then cured at 60° C. for 10 minutes.

Step 2: Reaction with functional layer compound—Fluorolink C10. Slides were sonicated in 1 wt % Fluorolink C10 (Perfluoro-polyethyleneoxide with carboxylic terminal sites, produced by Solexis) in 100% EtOH for 10 min. Solution was drained to a close container and final remains of solution were absorbed to a towel. Slides were cured at 140° C. in vacuum for 1 hour, and then washed with EtOH (100%) by sonication for 10 minute.

### Example 2

### Procedure for Depositing an Oleophilic/Hydrophobic Functional Coatings on Glass

The procedure described here was used, for example, to prepare Sample 21, which is characterized by its enhanced wetting capability of oils due to strong affinity interactions.

Cleaning: Glass slides are pretreated with 20% HCl/EtOH solution, followed by a wash in pure EtOH and pure acetone. The slides are dried in vacuum oven at 60° C. overnight.

Step 1: Surface reacted with coupling compound—APTES. Plates are dipped into 2% APTES solution in 95% EtOH for 10 minutes while sonicating. Plates are washed with EtOH (95%) by sonication for 1 minute, and then cured at 60° C. for 10 minutes.

Step 2: Reaction with functional layer compound—Dimer acid (C36, C₃₆H₆₄O₄) (dimer of unsaturated C18 fatty acid). First, slides are sonicated in 1 wt % dimer acid in 100% EtOH for 10 minutes. Solution is drained to a close container and final remains of solution are absorbed to a towel. Slides are cured at 140° C. in vacuum for 1 hour. Slides are washed with EtOH (100%) by sonication for 10 minutes.

### Example 3

### Procedures for Preparation of Surfaces with Smudge Resistance Characteristics

Glass slides were prepared according to the general procedures provided above. Specific treatment procedures for samples M1-M15 are provided in Table 1.

TABLE 1
Sample Preparation Procedures

| Sample ID | Surface Treatment |
|---|---|
| 1 | Cleaning, 30 sec fog (by Nebulizer) with 2 wt % APTES (in 95% ethanol), 1 min fog |
| | (nebulizer) with 1 wt % FLUOROLINK ® C (in ethanol); FLUOROLINK ® C is a |
| | perfluoro-polyethyleneoxide having terminal sites of carboxylic acid and MW of 1000 |
| | to 1400. |
| 2 | Cleaning, 1 min fog (by Nebulizer) with 2 wt % APTES (in 95% ethanol), 1 min fog |
| | (nebulizer) with 1 wt % FLUOROLINK ® C (in ethanol) |
| 3 | Cleaning, 2 min fog (by Nebulizer) with 2 wt % APTES (in 95% ethanol), 1 min fog |
| | (nebulizer) with 1 wt % FLUOROLINK ® C (in ethanol) |
| 4 | Cleaning, 1 min fog (by Nebulizer) with 2 wt % APTES (in 95% ethanol), 2 min fog |
| | (nebulizer) with 1 wt % FLUOROLINK ® C (in ethanol) |
| 5 | Cleaning, sonicate 2 min in 1 wt % APTES (in 95% ethanol), sonicate 1 min in 95% |
| | ethanol, cure at 60° C. for 10 min, 1 min fog (nebulizer) with 1 wt % FLUOROLINK ® C |
| | (in ethanol), cure at 140° C. vacuum, 1 hr, sonicate 30 min, air dry |
| 6 | Cleaning, sonicate 2 min in 1 wt % APTES (in 95% ethanol), sonicate 1 min in 95% |
| | ethanol, cure at 60° C. for 10 min, 2 min fog (nebulizer) with 1 wt % FLUOROLINK ® C |
| | (in ethanol), cure at 140° C. vacuum, 1 hr, sonicate 30 min, air dry |
| 7 | Cleaning, sonicate 2 min in 2 wt % APTES (in 95% ethanol), sonicate 1 min in 95% |
| | ethanol, cure at 60° C. for 10 min, 2 min fog (nebulizer) with 1 wt % FLUOROLINK ® |
| | C (in ethanol), cure at 140° C. vacuum, 1 hr, sonicate 30 min, air dry |
| 8 | Cleaning, sonicate 2 min in 2 wt % APTES (in 95% ethanol), sonicate 1 min in 95% |
| | ethanol, cure at 60° C. for 10 min, wipe with wet cloth with 1 wt % FLUOROLINK ® C, |
| | cure at 140° C. vacuum, 1 hr, sonicate 30 min, air dry |
| 9 | Cleaning, sonicate 2 min in 2 wt % APTES (in 95% ethanol), sonicate 1 min in 95% |
| | ethanol, cure at 60° C. for 10 min, wipe with wet cloth with 1 wt % FLUOROLINK ® C, |
| | rinse in ethanol, cure at 140° C. vacuum, 1 hr, sonicate 30 min, air dry |
| 10 | Cleaning, sonicate 2 min in 2 wt % APTES (in 95% ethanol), sonicate 1 min in 95% |
| | ethanol, cure at 60° C. for 10 min, dip 2 min in 1 wt % FLUOROLINK ® C, cure at |
| | 140° C. for 1 hr, sonicate 30 min in ethanol, air dry |
| 11 | Cleaning, sonicate 2 min in 2 wt % APTES (in 95% ethanol), sonicate 1 min in 95% |
| | ethanol, cure at 60° C. for 10 min, dip 2 min in 1 wt % FLUOROLINK ® C, cure at |
| | 140° C. for 1 hr, rinse in ethanol, air dry, sonicate 30 min, air dry |
| 12 | Cleaning, sonicate 2 min in 2 wt % APTES (in 95% ethanol), sonicate 1 min in 95% |
| | ethanol, cure at 60° C. for 10 min, dip 30 min in 1 wt % FLUOROLINK ® C, cure at |
| | 140° C. for 1 hr, sonicate 30 min in ethanol, air dry |
| 13 | Cleaning, sonicate 2 min in 2 wt % APTES (in 95% ethanol), sonicate 1 min in 95% |
| | ethanol, cure at 60° C. for 10 min, dip 30 min in 1 wt % FLUOROLINK ® C, cure at |
| | 140° C. for 1 hr, rinse in ethanol, air dry, sonicate 30 min, air dry |
| 14 | Cleaning, 1 dip coat (low, speed 40) in 1 wt % APTES (in 95% ethanol), cure at 60° C. |
| | for 10 min, 2 min fog(nebulizer) with 1 wt % FLUOROLINK ® C (in ethanol), cure at |
| | 140° C. vacuum, 1 hr, sonicate 30 min, air dry |
| 15 | Cleaning, 1 dip coat (low, speed 40) in 1 wt % APTES (in 95% ethanol), cure at 60° C. |
| | for 10 min, wipe with wet cloth with 1 wt % FLUOROLINK ® C, cure at 140° C. |
| | vacuum, 1 hr, sonicate 30 min, air dry |

### Example 4

### Contact and Sliding Angles for Treated Slides

It was found in the study that there is a very strong correlation between the capability to remove smudges from a treated surface (i.e., the “smudge resistance,” in part) and the oleophobicity of the surface. Oleic acid is a liquid acid that models the oils found on the human body. Therefore, the measurement of the contact angles and sliding angles of oleic acid droplets became an excellent screening method to identify good smudge resistance treatments. Contact and sliding angles of water are not so indicative. Slide angles of oleic acid and water droplets of various surface treatments, based on this invention, in comparison to commercial reagents treated according to published procedures were evaluated. Data are provided in Table 2.

TABLE 2
Sliding Angles Data of slides treated according to Examples 1 and 3.

| | | | Oleic | |
|---|---|---|---|---|
| | | Post | Acid | Water |
| Sample | | Preparation | Sliding | Sliding |
| ID | Description | Treatment | Angle | Angle |
| 18 | (1) Surface amination; (2) PF polyethyleneoxide | 2 min | 11° | Not |
| | (FLUOROLINK ® C) | sonication after | | moved |
| | | each test | | |
| 18 | Same | 1 h sonication | 10° | 26° |
| | | in iso-propanol | | |
| 18-6 | Same | Fresh | 8° | Not |
| | | | | moved |
| 18-6 | Same | 6000 wipes^{a} | 16° | — |
| 60-2 | Same | 3000 wipes | 18° | — |
| 85-2 | Same | 3000 wipes | 22° | — |
| 87-2 | Same | 6000 wipes | Oil | — |
| | | | smears | |
| Glass | Buffed with FLUOROLINK ® C and washed | — | 29° | 29° with |
| | | | | large |
| | | | | hysteresis |
| 1 | 30 sec fog^{b} with 2 wt % APTES (in 95% ethanol), | — | 29° | — |
| | 1 min fog with 1 wt % FLUOROLINK ® C (in | | | |
| | ethanol) | | | |
| 2 | 1 min fog with 2 wt % APTES (in 95% ethanol), | — | 30° | — |
| | 1 min fog with 1 wt % FLUOROLINK ® C (in | | | |
| | ethanol) | | | |
| 3 | 2 min fog with 2 wt % APTES (in 95% ethanol), | — | 36° | — |
| | 1 min fog with 1 wt % FLUOROLINK ® C (in | | | |
| | ethanol) | | | |
| 4 | 1 min fog with 2 wt % APTES (in 95% ethanol), | — | 31° | — |
| | 2 min fog with 1 wt % FLUOROLINK ® C (in | | | |
| | ethanol) | | | |
| 5 | Sonicate 2 min in 1 wt % APTES (in 95% | — | 36° | — |
| | ethanol), Sonicate 1 min in 95% ethanol, cure at | | | |
| | 60° C. for 10 min, 1 min fog with 1 wt % | | | |
| | FLUOROLINK ® C (in ethanol), Cure at 140° C. | | | |
| | under vacuum for 1 hr, sonicate 30 min, air dry | | | |
| 6 | Sonicate 2 min in 1 wt % APTES (in 95% | — | 32° | — |
| | ethanol), sonicate 1 min in 95% ethanol, cure at | | | |
| | 60° C. for 10 min, 2 min fog with 1 wt % | | | |
| | FLUOROLINK ® C (in ethanol), cure at 140° C. | | | |
| | under vacuum for 1 hr, sonicate 30 min, air dry | | | |
| 7 | Sonicate 2 min in 2 wt % APTES (in 95% | — | 14° | — |
| | ethanol), sonicate 1 min in 95% ethanol, cure at | | | |
| | 60° C. for 10 min, 2 min fog(nebulizer) with 1 wt % | | | |
| | FLUOROLINK ® C (in ethanol), cure at 140° C. | | | |
| | under vacuum for 1 hr, sonicate 30 min, air dry | | | |
| 8 | Sonicate 2 min in 2 wt % APTES (in 95% | — | 31° | — |
| | ethanol), sonicate 1 min in 95% ethanol cure at | | | |
| | 60° C. for 10 min, wipe with wet cloth with 1 wt % | | | |
| | FLUOROLINK ® C, cure at 140° C. under vacuum | | | |
| | for 1 hr, sonicate 30 min, air dry | | | |
| 9-1 | Sonicate 2 min in 2 wt % APTES (in 95% | — | 11° | — |
| | ethanol), sonicate 1 min in 95% ethanol, cure at | | | |
| | 60° C. for 10 min, wipe with wet cloth with 1 wt % | | | |
| | FLUOROLINK ® C, rinse in ethanol, cure at 140° C. | | | |
| | under vacuum for 1 hr, sonicate 30 min, air | | | |
| | dry | | | |
| 9-2 | Same | — | 9° | 55° |
| 9-3 | Same | — | 21° | — |
| 10 | Sonicate 2 min in 2 wt % APTES (in 95% | — | 22° | — |
| | ethanol), sonicate 1 min in 95% ethanol, | | | |
| | cure at 60° C. for 10 min, dip 2 min in 1 wt % | | | |
| | FLUOROLINK ® C, cure at 140° C. for 1 hr, | | | |
| | sonicate 30 min in ethanol, air dry | | | |
| 11 | Sonicate 2 min in 2 wt % APTES (in 95% | — | 18° | — |
| | ethanol), sonicate 1 min in 95% ethanol, | | | |
| | cure at 60° C. for 10 min, dip 2 min in 1 wt % | | | |
| | FLUOROLINK ® C, cure at 140° C. for 1 hr, rinse | | | |
| | in ethanol, air dry, sonicate 30 min, air dry | | | |
| 12 | Sonicate 2 min in 2 wt % APTES (in 95% | — | 17° | — |
| | ethanol), sonicate 1 min in 95% ethanol, cure at | | | |
| | 60° C. for 10 min, dip 30 min in 1 wt % | | | |
| | FLUOROLINK ® C, cure at 140° C. for 1 hr, | | | |
| | sonicate 30 min in ethanol, air dry | | | |
| 13 | Sonicate 2 min in 2 wt % APTES (in 95% | — | 22° | — |
| | ethanol), sonicate 1 min in 95% ethanol, cure at | | | |
| | 60° C. for 10 min, dip 30 min in 1 wt % | | | |
| | FLUOROLINK ® C, cure at 140° C. for 1 hr, rinse | | | |
| | in ethanol, air dry, sonicate 30 min, air dry | | | |
| 14 | 1 dip coat (low, speed 40) in 1 wt % APTES (in | — | 20° | — |
| | 95% ethanol), cure at 60° for 10 min, 2 min fog | | | |
| | with 1 wt % FLUOROLINK ® C (in ethanol), | | | |
| | cure at 140° C. under vacuum for 1 hr, sonicate 30 min, | | | |
| | air dry | | | |
| 15 | 1 dip coat (low, speed 40) in 1 wt % APTES (in | — | 16° | — |
| | 95% ethanol), cure at 60° C. for 10 min, wipe with | | | |
| | wet cloth with 1 wt % FLUOROLINK ® C, cure | | | |
| | at 140° C. under vacuum for 1 hr, sonicate 30 min, | | | |
| | air dry | | | |

^{a}Wipes were performed with a laboratory KIMWIPE ®
^{b}All fog treatments were by Nebulizer

### Example 5

### Surface Tension Measurements of Treated Glass Slides

Surface tension values of various surface treatments, based on this invention, in comparison to commercial reagents, treated according to published procedures were evaluated. The surface tension analysis was calculated by measuring the contact angles of drops of different liquids and then calculating the surface tension values from models using plots based on the measured contact angles. The values were calculated based on 2 different scientific models—the single-component model, and the two-component model. The single-component is the dominant model used by commercial entities to report surface tension. However, the two-component model provides much more information and seems to be more accurate. The two-component model extracts both polar and nonpolar components and better accounts for solvents that do not behave just by the physical attraction of surfaces, but are affected strongly by chemical affinity. The values from both models are given in Table 3 for different surface treatments including post treatment attempts to remove the coatings by solvents or physical wiping. In addition, oleic acid and water sliding angles were measured for slides having been prepared by the various methods. The sliding angle is the angle of the substrate, tilted from a horizontal position, at which a droplet starts slowly sliding. Data are provided in Table 3.

TABLE 3
Surface tension, sliding angle and contact angles of various treated glass slides

| | | | ST2^{a} | | | Oleic |
|---|---|---|---|---|---|---|
| | | | Total (polar, | | Water | Acid |
| | | Post Preparation | nonpolar) | ST1^{b} | SA^{c} | SA^{c} |
| Sample # | Description | Treatment | (dyne/cm) | (dyne/cm) | (CA^{d}) | (CA^{d}) |
| Untreated | Heat dried at | None | 52.2 (44.3, | 30.8 | NA | NA |
| Glass | 150° C. | | 7.9) | | (45°) | (16°) |
| 18 | (1) Surface | 2 min sonication | 18.0 | 13.0 | Not | 11° |
| | amination; (2) PF | after each test | (1.1, 16.9) | | moved | (68°) |
| | polyethyleneoxide | | | | at 90° | |
| | (FLUOROLINK ® | | | | (99°) | |
| | C) | | | | | |
| 18 | | 1 h sonication in i- | — | — | 26° | 10° |
| | | propanol | | | | |
| 18 | | Physical cleaning | — | — | 31° | 10° |
| | | with cloth and 15 min | | | | |
| | | sonication | | | | |
| 18 | | Buffed with 5% | — | — | 13° | 26° |
| | | FLUOROLINK ® | | | | |
| | | C in i-propanol and | | | | |
| | | a microfiber cloth | | | | |
| 18 | | After buffing with | — | — | Not | 22° |
| | | FLUOROLINK ® | | | moved | |
| | | C solution | | | | |
| 18 wiped | | After 400 wipes | — | — | Not | 9.5° |
| | | with micorfiber | | | moved | |
| | | cloth and a weight | | | | |
| | | of 300 g | | | | |
| 18 wiped | | After 1000 wipes | — | — | 60° | 11° |
| | | with micorfiber | | | | |
| | | cloth and a weight | | | | |
| | | of 300 g | | | | |
| 18 wiped | | After 3300 wipes | — | — | 40° | 10° |
| | | with micorfiber | | | | |
| | | cloth and a weight | | | | |
| | | of 300 g | | | | |
| 18 wiped | | After 10,000 wipes | — | — | Not | 12° |
| | | with micorfiber | | | moved | |
| | | cloth and a weight | | | | |
| | | of 300 g | | | | |
| 18-6 | | Fresh | — | — | Not | 8° |
| | | | | | moved | |
| 18-6 | | 30 min sonication | — | — | — | 7° |
| 18-6 | | 60 min sonication | — | — | — | 16° |
| 18-6 wiped | | 3000 wipes with 3 | — | — | — | 9° |
| | | layers of kimwipe | | | | |
| 18-6 wiped | | 3000 wipes with 3 | — | — | — | 11° |
| | | layers of kimwipe | | | | |
| 21 | Oleophilic; reacted | | 32.7 | 28.2 | NA | NA |
| | with dimer acid | | (10.6, 22.1) | | (56.7°) | (11.3°) |
| | according to | | | | | |
| | Example 2 | | | | | |
| 58 | Oleophobic - | Fresh | 22.4 | 11.4 | Not | 23° |
| | FLUOROLINK ® | | (5.9, 16.5) | | moved | (57°) |
| | S10 (1 wt % in | | | | (93°) | |
| | ethanol; sonicated/ | | | | | |
| | cure at 150° C./ | | | | | |
| | wash & sonicate | | | | | |
| | 15 min) | | | | | |
| 58 | | 1 h sonication in i- | — | — | Not | 18° |
| | | propanol | | | moved | |
| 58 | | Physical cleaning | — | — | Not | 17° |
| | | with cloth and 15 min | | | moved | |
| | | sonication | | | | |
| 59 | Oleophobic - | Fresh | 23.3 | — | Not | Too |
| | FLUOROLINK ® | | (0.7, 22.6) | | moved | spread |
| | C bonded to | | | | (96°) | (61°) |
| | aminopropyl | | | | | |
| | triethoxysilane (1 wt | | | | | |
| | % in ethanol; | | | | | |
| | sonicated/cure at | | | | | |
| | 150° C./wash & | | | | | |
| | sonicate 15 min) | | | | | |
| 59 | | 1 h sonication in i- | — | — | Not | 26° |
| | | propanol | | | moved | |
| 60 | Oleophobic - | Fresh | 19.5 | 16.8 | Not | 23° |
| | FLUOROLINK ® | | (1.6, 17.9) | | moved | (61°) |
| | S10 (1 wt % in | | | | (94°) | |
| | ethanol; sonicated/ | | | | | |
| | washed by | | | | | |
| | sonication in clean | | | | | |
| | solvent/cured at | | | | | |
| | 150° C./wash & | | | | | |
| | sonicate 15 min) | | | | | |
| 60 | | 1 h sonication in i- | — | — | Not | 15° |
| | | propanol | | | moved | |
| 60 | | Physical cleaning | — | — | | 13° |
| | | with cloth and 15 min | | | | |
| | | sonication | | | | |
| 60-2a | | Before additional | — | — | 44° | 9° |
| | | sonication | | | | |
| 60-2b | | Before additional | — | — | 65° | 13° |
| | | sonication | | | | |
| 60-2c | | After additional | — | — | Not | 15° |
| | | sonication (sliding | | | moved | |
| | | slower than MT- | | | | |
| | | 87-2c) | | | | |
| 60-2b | | After additional | — | — | Not | 19° |
| | | sonication | | | moved | |
| 60-2 wiped | | Microfiber cloth | — | — | | 16° |
| 60-2 wiped | | Microfiber cloth | — | — | | 16° |
| | | plus 5 min | | | | |
| | | sonication | | | | |
| 61 | Oleophobic - | Fresh | — | — | Not | Too |
| | FLUOROLINK ® | | | | moved | spread |
| | C bonded first to | | | | | |
| | aminopropyl | | | | | |
| | triethoxysilane | | | | | |
| | before applied at | | | | | |
| | the slide's surface | | | | | |
| | (1 wt % in ethanol; | | | | | |
| | sonicated/washed | | | | | |
| | by sonication in | | | | | |
| | clean solvent/ | | | | | |
| | cured at 150° C./ | | | | | |
| | wash & sonicate | | | | | |
| | 15 min) | | | | | |
| 61 | | 1 h sonication in i- | — | — | Not | Too |
| | | propanol | | | moved | spread |
| 62 | Oleophobic - | Fresh | 22.9 | 14.6 | Not | 26° |
| | FLUOROLINK ® | | (5.2, 17.8) | | moved | (55°) |
| | S10 (dip coat in | | | | (93°) | |
| | 1 wt % | | | | | |
| | FLUOROLINK ® | | | | | |
| | S10, cure at 150° C. | | | | | |
| | for 15 min/wash & | | | | | |
| | sonicated 15 min) | | | | | |
| 62 | | 1 h sonication in i- | — | — | Not | 19° |
| | | propanol | | | moved | |
| 62 | | Physical cleaning | — | — | Not | 16° |
| | | with cloth and 15 min | | | moved | |
| | | sonication | | | | |
| 63 | Oleophobic - | Fresh | — | — | Not | Too |
| | FLUOROLINK ® | | | | moved | spraed |
| | C bonded to | | | | | |
| | aminopropyl | | | | | |
| | triethoxysilane | | | | | |
| | (dip coat in 1 wt % | | | | | |
| | FLUOROLINK ® | | | | | |
| | S10, cure at 150° C. | | | | | |
| | for 15 min/ | | | | | |
| | wash & sonicated | | | | | |
| | 15 min) | | | | | |
| | | 1 h sonication in i- | — | — | Not | Too |
| | | propanol | | | moved | spread |
| 70 | (1) surface | 1 h sonication | 17.3 | 12.4 | Not | 10° |
| | amination like in | | (1.0, 16.3) | | moved | (76°) |
| | MT-18 | | | | (103°) | |
| | (2) Mixture of 1:1 | | | | | |
| | mol of | | | | | |
| | FLUOROLINK ® | | | | | |
| | C and dimer acid | | | | | |
| 71 | (1) surface | 1 h sonication | 20.6 | 14.2 | Not | 29° |
| | amination like in | | (3.6, 17.0) | | moved | (57°) |
| | MT-18 | | | | (90°) | |
| | (2) Mixture of 1:1 | | | | | |
| | mol of | | | | | |
| | FLUOROLINK ® | | | | | |
| | C and dimer acid | | | | | |
| 72 | Mixture of 1:1 | 1 h sonication | 20.9 | 11.6 | Not | 27° |
| | mol of | | (5.4, 15.5) | | moved | (60°) |
| | FLUOROLINK ® | | | | (91°) | |
| | C and dimer acid | | | | | |
| 85 | 2 wt % | 15 min sonication | 19.4 | 14.4 | 77° | 14° |
| | 1H,1H,2H,2H- | | (2.1, 17.3) | | (94°) | (57°) |
| | perfluorodecyltriethoxysilane; | | | | | |
| | in | | | | | |
| | ethanol | | | | | |
| | (sonication/heating | | | | | |
| | slides in | | | | | |
| | solution) | | | | | |
| 85 | | 1 h sonication in i- | — | — | Not | 26° |
| | | propanol | | | moved | |
| 85-2a | | Fresh | — | — | 65° | 22° |
| 85-2b | | Fresh | — | — | 65° | 16° |
| 85-2c | | After further | — | — | Not | 15° |
| | | sonication; faster | | | moved | |
| | | than MT-60-2c | | | | |
| | | | — | — | | |
| 85-2d | | After further | — | — | Not | 18° |
| | | sonication; | | | moved | |
| MT-85-2 | | 3000 wipes with | — | — | | 18° |
| wiped | | microfiber cloth | | | | |
| 86 | 2 wt % | 15 min sonication | 21.8 | 11.9 | 61° | 25° |
| | tridecafluoro- | | (5.1, 16.7) | | (94°) | (52°) |
| | 1,1,2,2- | | | | | |
| | tetrahydrooctyl- | | | | | |
| | dimethylchlorosilane | | | | | |
| | in ethanol | | | | | |
| | (sonication/heating | | | | | |
| | slides in | | | | | |
| | solution) | | | | | |
| 86 | | 1 h sonication in i- | — | — | 77° | 27° |
| | | propanol | | | | |
| M87 | 2 wt % | 15 min sonication | 19.8 | 8.5 | 70° | 35° |
| | (tridecafluoro- | | (5.8, 14.0) | | (104°) | (61°) |
| | 1,1,2,2- | | | | | |
| | tetrahydrooctyl)- | | | | | |
| | trichlorosilane in | | | | | |
| | ethanol | | | | | |
| | (sonication/heating | | | | | |
| | slides in | | | | | |
| | solution) | | | | | |
| 87 | | 1 h sonication in i- | — | — | 79° | 28° |
| | | propanol | | | | |
| 87-2a | | Fresh | — | — | Not | 20° |
| | | | | | moved | |
| 87-2b | | Fresh | — | — | 44° | 17° |
| 87-2c | | After further | — | — | Not | 20° |
| | | sonication | | | moved | |
| 87-2 wiped | | 3000 wipes with | — | — | | 21° |
| | | micro fiber cloth | | | | |
| 87-2 wiped | | 3000 wipes with | — | — | — | 12° but |
| | | kimwipe 3 layer | | | | wide |
| | | tissue | | | | drop |
| 88 | FLUOROLINK ® | 5 min sonication | 28.5 | 20.0 | 76° | 14° |
| | C without surface | | (8.8, 19.7) | | (67°) | (26°) |
| | amination | | | | | |
| 88 | | 1 h sonication in i- | | | Not | 17° |
| | | propanol | | | moved | |
| 89 | 2 wt % | 1 h sonication in i- | 19.4 | 15.2 | Not | 29° |
| | AQUAPHOBE ® | propanol | (1.0, 18.4) | | moved | (67°) |
| | CF (chlorinated | | | | (99°) | |
| | fluoroalkylmethylsiloxane; | | | | | |
| | in ethanol | | | | | |
| | (sonication/heating | | | | | |
| | slides in | | | | | |
| | solution) | | | | | |

^{a}ST2 = Surface Tension, two-parameter model (Zisman Theory)
^{b}ST1 = Surface Tension, one-parameter model (Owens/Windt theory, J Appl Poly Sci 12 (1969)1741; J Phys Chem 64 (1960) 561
^{c}SA = Sliding Angle
^{d}CA = Contact Angle

With reference to FIG. 3, and as described previously, four samples were compared for various data points. For the “fingerprint wipe strokes” data, a fingerprint was prepared on a surface, and the number of wipes was recorded by moving the smudged slide placed with the fingerprint down and in contact with a microfiber cleaning cloth mounted on a plywood board. A cylindrical weight of 300 g was then placed on the back side of the tested slide and the slide was moved in strokes of 4″ with a repeating stroke pattern of moving the loaded slide to the left-right-up-down and so on. In the good cases, the visual presence of the fingerprint was detected by a naked eye. If the smudge was still observed after 8 strokes, then the slide was further inspected after rounds of 4 strokes. Regarding the “slide angle” data, this is the angle of tilting a slide with a deposited droplet of 20 microliter oleic acid at which the drops start to move down the generated slope. Thus, a smaller angle to move the oleic acid droplet indicates better oleophobicity of the surface and better smudge resistance.

### Example 6

### Artificial and Real Fingerprint Testing

Artificial and real fingerprints were deposited on slides according to the procedures described above. Table 4 provides data for artificial smudges. Table 5 provides data for real fingerprints. The wiping procedure and modified wiping procedures were used as indicated.

TABLE 4
Post coating cleaning (wiping) tests with deposited artificial fingerprints

| | | | Weight | Weight | Weight | Number of |
|---|---|---|---|---|---|---|
| | | Weight of | after 1 | after 2 | after 3 | strokes for |
| | | smudge | stroke | strokes | strokes | haze |
| Sample ID | Type of slide | (mg) | (mg) | (mg) | (mg) | removal |
| Untreated | Untreated | 0.26 | 0.13 | 0.10 | 0.09 | 13 |
| (1)* | | | | | | |
| (2)* | Untreated | 0.58 | 0.23 | 0.14 | 0.14 | 15 |
| (3)* | Untreated | 0.72 | 0.22 | 0.12 | 0.10 | 15 |
| (4)* | Untreated | 0.13 | 0.10 | 0.09 | 0.08 | 13 |
| 18 (1)* | Oleophobic | 0.34 | 0.00 | 0.00 | — | 2 |
| | (1) Surface amination | | | | | |
| | with aminopropyl- | | | | | |
| | triethoxysilane; (2) PF | | | | | |
| | polyethyleneoxide | | | | | |
| | (FLUOROLINK ® C) | | | | | |
| | with terminal | | | | | |
| | carboxylic groups | | | | | |
| 18 (2)* | Oleophobic | 1.19 | 0.05 | 0.04 | 0.02 | 3 |
| 18 (3)* | Oleophobic | 0.11 | 0.00 | 0.00 | — | 2 |
| 18 (4)* | Oleophobic | 0.48 | 0.01 | 0.00 | --- | 2 |
| 21 (1)* | Oleophilic | 0.14 | 0.04 | 0.00 | 0.00 | 10 |
| | (1) Surface amination; | | | | | |
| | (2) dimer acid | | | | | |
| 21 (2)* | Oleophilic | 0.71 | 0.11 | 0.07 | 0.07 | 11 |
| 21 (3)* | Oleophilic | 0.68 | 0.09 | 0.02 | 0.00 | 10 |

Testing with Artificial Fingerprint Formulation
(sebum, made by mixing fatty acids, monoglycerides, squalene and fatty
esters as described at the beginning of the examples)

| | | |
|---|---|---|
| 18 | | 6 |
| 18 wiped | After 1100 wipes | 8 |
| | motions for abrading | |
| | the treatment | |
| MT-21 | | 28 |
| 21 (2) | | 24 |

*Modified Wiping Procedure used where the whipping strokes were performed with 90° change of the stroke direction after each stroke.

TABLE 5
Cleaning results with real deposited fingerprints

| | | No. | |
|---|---|---|---|
| | | strokes | |
| Sample | | for haze | |
| ID | Type of slide | removal | Comments |
| (1)* | Untreated glass | 20 | Hard to completely remove |
| (2)* | Untreated glass | 38 | Very hard to completely remove |
| (3) | Untreated glass | 28 | |
| (4) | Untreated glass | 36 | |
| (4)# | Untreated glass; smeared with | >24 | |
| buffed | artificial sebum solution and buffed | | |
| (5) | Untreated glass | 30 | |
| (5) | Untreated glass | 12 | Wiped with an old T shirt cotton |
| | | | cloth |
| UT | Untreated glass | 10 | Wiped with an old T shirt cotton |
| (6) | | | cloth |
| 18 (1)* | Oleophobic; (1) Surface amination; | 1-2 | 1. Hard to deposit fingerprints |
| | (2) PF polyethyleneoxide | | 2. Vaguely seen after 1 stroke |
| | (FLUOROLINK ® C) | | |
| 18 (2)* | Oleophobic | 2-3 | 1. Hard to deposit fingerprints |
| | | | 2. Vaguely seen after 1 and 2 |
| | | | strokes |
| 18 buffed | Oleophobic; Buffed with cloth after | 1 | |
| | deposition of 2% artificial sebum | | |
| | solution | | |
| 18 (3) | Oleophobic | 2 | |
| 18 (4) | Oleophobic | 4 | |
| 18 (5) | Oleophobic | 2-3 | Wiped with an old T shirt cotton |
| | | | cloth |
| 18 (6) | Oleophobic | 1-2 | Wiped with an old T shirt cotton |
| | | | cloth |
| 18 wiped | 1100 wipes/cloth | 6 | Wiped with microfiber cloth |
| | | | mounted around 300 g weight |
| | | | cylinder and held with a rubber |
| | | | band after stretching. The |
| | | | multiple wiping procedure was |
| | | | performed to resemble long-term |
| | | | usage and analyze the potential of |
| | | | physical removal of the |
| | | | functional coating layer. In this |
| | | | procedure the cloth is mounted to |
| | | | the weight and not to the wooden |
| | | | board. |
| 18 wiped | 3300 wipes/cloth | 4 | Wiped with microfiber cloth and |
| | | | 300 g weight |
| 18 wiped | 10,000 wipes | 4 | Wiped with microfiber cloth and |
| | | | 300 g weight |
| 18-6 | 3000 wipes/Kimwipe | 3 | Wiped with Kimwipe 3 layer |
| wiped | | | paper tissue and 300 g weight, |
| | | | similarly to the above procedure |
| | | | (but with a paper tissue rather |
| | | | than microfiber cloth) |
| 18-6 | 6000 wipes/Kimwipe | 2 | Wiped with Kimwipe 3 layer |
| wiped | | | tissue and 300 g weight |
| 21 (1)* | Oleophilic | 24 | Difficult to completely remove |
| | (1) Surface amination; (2) dimer acid | | |
| | (a dimerization product of 2 oleic | | |
| | acids possessing 2 terminal sites of | | |
| | carbocxylic acid. | | |
| 21 (2) | Oleophilic | >24 | Fingerprint was left overnight |
| | | | before wiping |
| 21 (3) | Oleophilic | 32 | |
| 21 buffed | Oleophilic | >24 | |
| (1)* | Buffed with cloth after deposition of | | |
| | 2% artificial sebum solution | | |
| 21 buffed | Oleophilic | 10 | Fingerprints are not shown |
| (2) | | | anymore but overall haze may |
| | | | exist |
| 21 buffed | Oleophilic | 16 | |
| (3) | | | |
| 21 buffed | | 8 | |
| (4) | | | |
| 21 buffed | | 14 | |
| (5) | | | |
| 21 buffed | | 7-8 | |
| (5) | | | |
| 21 | | 12 | With old T shirt cloth |
| (1) | | | |
| 58 (1)* | Oleophobic - FLUOROLINK ® S10; | 10 | 1. more deposition of fingerprint |
| | alkoxysilane terminal sites can be | | than # 18 |
| | bonded to the substrate without | | 2. Harder to remove than # 18; |
| | performing the initial coupling | | indicating the advantage of the 2 |
| | compound step. | | step process (i.e., attaching |
| | (1 wt % in ethanol; sonicated; cure at | | coupling compound, then |
| | 150° C.; wash & sonicate 15 min) | | attaching functional layer |
| | | | compound). |
| | | | 3. i-Propanol wets surface more |
| | | | than # 18 during cleaning by |
| | | | rinsing |
| 58 (2) | | 9 | After cloth wiping and sonication |
| | | | MT-58 (1) |
| 60 (1)* | Oleophobic - FLUOROLINK ® S10 | 7 | 1. more deposition of fingerprint |
| | (1 wt % in ethanol; sonicated/washed | | than MT 18 |
| | by sonication in clean solvent/cured | | 2. Harder to remove than # 18 |
| | at 150° C./wash & sonicate 15 min) | | 3. i-Propanol wets surface more |
| | | | than # 18 during cleaning by |
| | | | rinsing |
| 60 (2) | | 7 | |
| 60 (3) | After cleaning by sonication | 10 | |
| 60-2 | | 8 | |
| 60-2 | 3000 micro fiber cloth wipes | 16 | The smudge resistance properties |
| | | | deteriorate much faster than # 18 |
| 70 | Repeat of MT-18 | 3 | Fingerprint stays overnight |
| 70 (2) | After cleaning by sonication | 2 | |
| 85* | Fluorocarbon treated | 10 | 1. more deposition of fingerprint |
| | (2 wt % 1H,1H,2H,2H- | (sample | than MT 18 |
| | perfluorodecyltriethoxysilane; in | slightly | 2. Harder to remove than MT-18 |
| | ethanol; sonicated 60 min then 80° C. | hazy | |
| | for 2 h; excess of material causing | before | |
| | haze and spotty look was removed by | smudging) | |
| | a dry cloth, washed cleaning and re- | | |
| | sonicated for 15 min in i-propanol) | | |
| 85 (2) | After cleaning by sonication | 12 | |
| 85-2 | | 20 | |
| 85-2 | 3000 micro fiber wipes | 20 | |
| 85-2 | 3000 kimwipe | 24 | |
| 86* | Fluorocarbon treated | 30 | 1. more deposition of fingerprint |
| | (2 wt % tridecafluoro-1,1,2,2- | (sample | than MT 18 |
| | tetrahydrooctyl-dimethylchlorosilane | slightly | 2. Harder to remove than MT-18 |
| | in ethanol, sonicated 60 min then | hazy | 3. i-Propanol wets surface more |
| | 80° C./1 h) | before | than MT-18 during cleaning by |
| | | smudging) | rinsing |
| 86 | | 30 | |
| 87 (1)* | Fluorocarbon treated | 6 | 1. more deposition of fingerprint |
| | (2 wt % tridecafluoro-1,1,2,2- | (sample | than MT 18 |
| | tetrahydrooctyl-dimethylchlorosilane | slightly | 2. Harder to remove than MT-18 |
| | in ethanol, sonicated 60 min then | hazy | 3. i-Propanol wets surface more |
| | 80° C./1 h) | before | than MT-18 during cleaning by |
| | | smudging) | rinsing |
| 87 (2) | | 16 | Same specimen as the first one |
| | | | after cloth cleaning and |
| | | | sonication; showing property |
| | | | deterioration |
| MT-87 | After further cleaning by sonication | 16 | |
| (3) | | | |
| 87-2 | | 12 | |
| 87-2 | 3000 micro fiber wipes | 24 | |
| 87-2 | 3000 kimwipe 3 layer tissue wipes | 12 | |
| | (before sonication) | | |
| 87-2 | 3000 kimwipe 3 layer tissue wipes | 20 | |
| | (after sonication) | | |
| 87-2 | 6000 kimwipe 3 layer tissue wipes | 24 | |
| | (after sonication) | | |

*Modified Wiping Procedure used where the whipping strokes were performed with 90° change of the stroke direction after each stroke.

### Example 6

### The Need for Step 1

The set of experiments shown in Table 8 (as compared with the data from Table 7) demonstrate the critical necessity to proceed with Step 1 in which the coupling compound is first bonded to the activated surface.

Procedure for slides used in Table 8. (1) Soak glass slides in 20 wt % HCl (37 wt %)/ethanol (95 wt %) for 1 hour. (2) Rinse glass slides with 95% ethanol and air dry. (3) Soak glass slides in 1% FLUOROLINK® L/100% ethanol while sonicating for 2 min and followed by sonicating in 95% ethanol for 1 min to remove excess. Air dry. (4) Heat in vacuum oven at 80° C. or room temperature, ambient conditions. (5) Sonicate in IPA for 30 min to remove the excess and air dry.

TABLE 6
Results for smudge resistance functional coating in the
absence of a coupling compound

| | | | Contact Angle of 20 μl |
|---|---|---|---|
| ID | 2% APTES | 1% Fluorolink L | Oleic Acid Droplet |
| 103-1A | None | Dipping temp. 40° C.; | Wipe cleaned to remove |
| | | Sonication | excess (36°) |
| | | 80° C. vacuum heat. | Sonicated in IPA for |
| | | | 30 min (29°) |
| 103-1B | None | Dipping temp. 40° C.; | Wipe cleaned to remove |
| | | Sonication | excess (35°) |
| | | 80° C. vacuum heat. | Sonicated in IPA for |
| | | | 30 min (36°) |
| 103-2A | None | Dipping temp. 40° C.; | Wipe cleaned to remove |
| | | Sonication. | excess (31°) |
| | | RT air heat. | Sonicated in IPA for |
| | | | 30 min (39°) |
| 103-2B | None | Dipping temp. 40° C.; | Wipe cleaned to remove |
| | | Sonication. | excess (34°) |
| | | RT air heat. | Sonicated in IPA for |
| | | | 30 min (28°) |

### Example 7

### The Effects of Sonication During Soaking Steps

The set of experiments shown in Table 9 demonstrate that when Step 2 of bonding the functional layer compound is performed at room temperature, sonication may have a potential role, especially when a polymeric compound is used. The results of these experiments are then compared with the results from Example 11.

Procedure: Glass slides were soaked in 20 wt % HCl (37 wt %)/ethanol (95 wt %) for 1 hour, rinsed with 95% ethanol and air dried. A solution of 2 wt % Aminopropyltriethoxysilane (APTES) in 95% ethanol was prepared and transferred to a staining jar. The solution was warmed up at various temperatures and the glass slides were immersed into the staining jar and fill it up with 2 wt % APTES solution. The slided soaked for 5 min at the various temperatures before rinsing with 95 wt % Ethanol. They were then heated in an oven at 60° C. for 10 min.

Next, the cured slides were immersed in a solution of 1 wt % FLUOROLINK® C in 100% Ethanol and soaked for 10 min at various temperatures. The treated slides were rinsed with 95% Ethanol and blot excess was wiped with a piece of KIMWIPE®. The slides were heated at 140° C. under vacuum for 1 hour. Then, they were wiped with a piece of KIMWIPE® saturated with WINDEX® to remove any excess of the Fluorolink traces.

TABLE 7
Contact angle measurement as a function of changing
the temperature during the immersion steps.

| | | | Contact Angle of |
|---|---|---|---|
| ID | 2% APTES | 1% Fluorolink C | 20 μl oleic acid |
| 103-3A | Dipping temp - RT | Dipping temp - RT | Sonicated in Ethanol |
| | No sonication | No sonication | 10 min (59°) |
| | heat at 60° C., air. | Heat at 140° C., | Sonicated in IPA for |
| | | vacuum. | 4.5 hours (51°) |
| 103-3B | Dipping temp - RT | Dipping temp - RT | Sonicated in Ethanol |
| | No sonication | No sonication | 10 min (59°) |
| | Heat at 60° C., air. | Heat at 140° C., | Sonicated in |
| | | vacuum. | WINDEX ® for |
| | | | 4.5 hours (30°) |

### Example 8

### Effects of Heating at Different Processing Steps

The set of experiments shown in Table 10 demonstrates that when Step 1 and/or Step 2 are performed at temperatures above room temperature, sonication may have a lesser role and may be eliminated.

Procedure: Glass slides were soaked in 20 wt % HCl (37 wt %)/ethanol (95 wt %) for 1 hour, rinsed with 95% ethanol and air dried. A solution of 2 wt % Aminopropyltriethoxysilane (APTES) in 95% ethanol was prepared and transferred to a staining jar. The solution was warmed up at various temperatures and the glass slides were immersed into the staining jar and fill it up with 2 wt % APTES solution. The slided soaked for 5 min at the various temperatures before rinsing with 95 wt % Ethanol. They were then heated in an oven at 60° C. for 10 min.

Next, the cured slides were immersed in a solution of 1 wt % FLUOROLINK® C in 100% Ethanol and soaked for 10 min at various temperatures. The treated slides were rinsed with 95% Ethanol and blot excess was wiped with a piece of KIMWIPE®. The slides were heated at 140° C. under vacuum for 1 hour. Then, they were wiped with a piece of KIMWIPE® saturated with WINDEX® to remove any excess of the Fluorolink traces.

TABLE 8
Contact Angles and their retention after soaking in cleaning solutions as a
function of immersion temperature during Step 1 and/or Step 2

| ID | 2% APTES | 1% Fluorolink C | Contact Angle of 20 μl Oleic Acid |
|---|---|---|---|
| 103-4A | Dipping temp. 40° C. | Dipping temp. 40° C. | WINDEX ® wiped to remove excess (64°) |
| | No sonication | No sonication | Sonicated in IPA for 10 min (64°) |
| | Heat at 60° C., air. | Heat at 140° C., | Sonicated in IPA for 5 hour (64°) |
| | | vacuum. | |
| 103-4B | Dipping temp. 40° C. | Dipping temp. 40° C. | WINDEX ® wiped to remove excess (64°) |
| | No sonication | No sonication | Sonicated in Windex for 10 min (64°) |
| | Heat at 60° C., air. | Heat at 140° C., | Sonicated in Windex for 5 hour (64°) |
| | | vacuum. | |
| 103-4C | Dipping temp. 40° C. | Dipping temp. 40° C. | WINDEX ® wiped to remove excess (66°) |
| | No sonication | No sonication | |
| | Heat at 60° C., air. | Heat at 140° C., | |
| | | vacuum. | |
| 103-4D | Dipping temp. 40° C. | Dipping temp. 40° C. | WINDEX ® wiped to remove excess (66°) |
| | No sonication | No sonication | |
| | Heat at 60° C., air. | Heat at 140° C., | |
| | | vacuum. | |
| 103-4E | Dipping temp. 40° C. | Dipping temp. 40° C. | WINDEX ® wiped to remove excess (64°) |
| | No sonication | No sonication | |
| | Heat at 60° C., air. | Heat at 140° C., | |
| | | vacuum. | |
| 103-5A | Dipping temp. 65° C. | Dipping temp. 65° C. | WINDEX ® wiped to remove excess (57°) |
| | No sonication | No sonication | Sonicated in IPA for 15 min (65°) |
| | Heat at 60° C., air. | Heat at 140° C., | |
| | | vacuum. | |
| 103-5B | Dipping temp. 65° C. | Dipping temp. 65° C. | WINDEX ® wiped to remove excess (59°) |
| | No sonication | No sonication | Sonicated in WINDEX ® for 15 min (58°) |
| | Heat at 60° C., air. | Heat at 140° C., | Sonicated in WINDEX ® for 0.5 hour (65°) |
| | | vacuum. | |
| 103-5C | Dipping temp. 65° C. | Dipping temp. 65° C. | WINDEX ® wiped to remove excess (64°) |
| | No sonication | No sonication | Sonicated in IPA for 15 min (63°) |
| | Heat at 60° C., air. | Heat at 140° C., | Sonicated in Ethanol for 0.5 hour (65°) |
| | | vacuum. | |
| 103-5D | Dipping temp. 65° C. | Dipping temp. 65° C. | WINDEX ® wiped to remove excess (63°) |
| | No sonication | No sonication | Sonicated in IPA for 15 min (60°) |
| | Heat at 60° C., air. | Heat at 140° C., | |
| | | vacuum. | |
| 103-5E | Dipping temp. 65° C. | Dipping temp. 65° C. | WINDEX ® wiped to remove excess (64°) |
| | No sonication | No sonication | Sonicated in IPA for 15 min (66°) |
| | Heat at 60° C., air. | Heat at 140° C., | |
| | | vacuum. | |
| 103-6A | Dipping temp. 63° C. | Dipping temp. 54° C. | WINDEX ® wiped to remove excess (62°) |
| | No sonication | No sonication | Sonicated in IPA for 15 min (59°) |
| | Heat at 60° C., air. | Heat at 140° C., | |
| | | vacuum. | |
| 103-6B | Dipping temp. 63° C. | Dipping temp. 54° C. | WINDEX ® wiped to remove excess (60°) |
| | No sonication | No sonication | Sonicated in IPA for 15 min (63°) |
| | Heat at 60° C., air. | Heat at 140° C., | Sonicated in Ethanol for 0.5 hour (64°) |
| | | vacuum. | |
| 103-6C | Dipping temp. 63° C. | Dipping temp. 54° C. | WINDEX ® wiped to remove excess (63°) |
| | No sonication | No sonication | Sonicated in IPA for 15 min (63°) |
| | Heat at 60° C., air. | Heat at 140° C., | Sonicated in Ethanol for 0.5 hour (63°) |
| | | vacuum. | |
| 103-6D | Dipping temp. 63° C. | Dipping temp. 54° C. | WINDEX ® wiped to remove excess (61°) |
| | No sonication | No sonication | Sonicated in IPA for 15 min (61°) |
| | Heat at 60° C., air. | Heat at 140° C., | |
| | | vacuum. | |
| 103-6E | Dipping temp. 63° C. | Dipping temp. 54° C. | WINDEX ® wiped to remove excess (60°) |
| | No sonication | No sonication | Sonicated in IPA for 15 min (60°) |
| | Heat at 60° C., air. | Heat at 140° C., | |
| | | vacuum. | |

### Example 9

### Alternative Reagents for Step 1 and Step 2

Step 1 was altered by performing Step 1 with an epoxy alkoxysilane as an alternative coupling agent. Subsequently, different polyfluoroether reagents were used to allow chemical reactivities with the coupling agent and forming covalent bonding between the two. The reagent selection, reaction conditions and surface tension results are summarized in Table 9.

TABLE 9
Alternative Reagents

| | | | Surface Energy | | | | |
|---|---|---|---|---|---|---|---|
| | Substituents or | | 2-component | | Contact Angle | | |
| | Modifiers for Step | Curing | model (polar; | 1-comp. | | Oleic | n- |
| Sample # | 1 & 2 | Conditions | nonpolar) | model | Water | Acid | octane |
| 91 | 2% GPMS; 1% | 140° C./1 h | 21.0(16.1; 4.9) | ~5 | 90° | 66° | 39° |
| | Fluorolink-T; | | | | | | |
| | Acetone | | | | | | |
| 92 | 2% GPMS; 1% | 140° C./1 h | 21.0(16.1; 4.9) | ~5 | 90° | 63° | 36° |
| | Fluorolink-T10; | | | | | | |
| | Acetone | | | | | | |
| 93 | 2% GPMS; 1% | 140° C./1 h | 22.8(16.1; 6.7) | ~5 | 88° | 63° | 39° |
| | Fluorolink; D10/H; | | | | | | |
| | Acetone | | | | | | |
| 94 | 2% GPMS; 1% | 140° C./1 h | 21.8(16.2; 5.6) | ~5 | 90° | 63° | 39° |
| | Fluorolink-T; THF | | | | | | |
| 95 | 2% GPMS; 1% | 140° C./1 h | 20.7(15.4; 5.3) | ~3 | 90° | 66.1° | 39° |
| | Fluorolink-T10; | | | | | | |
| | THF | | | | | | |
| 96 | 2% GPMS; 1% | 140° C./1 h | 22.4(15.6; 6.8) | ~5 | 87° | 63° | 40° |
| | Fluorolink-D10/H; | | | | | | |
| | THF | | | | | | |
| 97 | 2% APTES; 1%; | 140° C./1 h | 19.3(14.9; 4.4) | ~2 | 90° | 72° | 40° |
| | Fluorolink C; | | | | | | |
| | EtOH | | | | | | |
| 98 | 2% APTES-1% | 140° C./1 h | 19.4(14.3; 5.1) | N/A | 90° | 70° | 41° |
| | Fluorolink C; EtOH | | | | | | |
| 99 | 2% APTES; 1% | 140° C./1 h | 23.3(14.8; 8.6) | N/A | 86° | 69° | 42° |
| | Fluorolink C10; | | | | | | |
| | EtOH | | | | | | |

Abbreviations:
GPMS: 3-Glycidyloxypropytrimethoxysilane (epoxy);
APTES—aminopropyltriethoxysilane;
THF—tetrahydrofurane;
EtOH—ethanol
Notes:
Fluorolink reagents (perfluoro polyethylenether from Solexis): C, C10: carboxy terminated;
T, T10 -- oligoethyleneether-carbinol terminated;
FL D10/H -- carbiol terminated.

### Example 10

### Preparation of Smudge Resistance Coatings with Alternative Reagent for Step 2

Low-temperature processing of smudge resistance functional coating was carried out using the following general procedure for further process modifications.

Cleaning: (1) Soak glass slides in 20 wt % HCl (37 wt %)/ethanol (95 wt %) for 1 hour. (2) Sonicate the slides in 95% ethanol for 1 min and dry at 60° C.

Step 1: Coupling compound deposition. (1) Prepare 85 g of 2 wt % aminopropyl triethoxysilane (APTES) in 95% ethanol and transfer to a staining jar. (2) Load 8 pieces of glass slides into staining jar and fill staining jar with 2 wt % APTES solution. Sonicating for 2 min and followed by sonicating in 95 wt % ethanol for 1 min. (3) Heat in oven at 60° C. for 10 min.

Step 2: Bonding functional layer compound. (1) Prepare 85 g of 1 wt % FLUOROLINK® L (perfluoro polyethylene-oxide with methoxy carboxylate terminal sites, produced by Solexis) in 100% ethanol (additives such as hydrolysis catalyst and dehydration reagents can optionally be added). (2) Soak Step 1 treated slides in above solution for 2 min with sonication or for 5 min without sonication. (3) Immerse in 95% ethanol and sonicate for 1 min or simply rinse with 95% ethanol to remove excess. (4) React the above fluorinated coating under various temperatures not to exceed 105° C. This step may be performed at ambient environment, under vacuum, or inert conditions (5) Wash excess of unreacted functional layer compound by sonicating in ethanol for a few minutes, followed by sonicating in isopropyl alcohol (IPA) for 30 min. (6) Dry in ambient air.

Table 6 presents data for variables of the above procedure and testing of the bonding durability of the coating by sonicating the coatings in cleaning solvents and solutions typically found in consumer homes.

TABLE 10
Retention testing of Smudge resistance coatings in cleaning
solutions as a function of coating process variables.

| | | Retention of Contact Angle |
|---|---|---|
| | | after Post Process |
| | | Sonication (Contact angle |
| Sample # | Procedure Description | of 20 μl oleic acid) |
| 101A | Substrate: Glass slide, regular cleaning | Isopropyl alcohol (IPA): 0.5 |
| | procedure. | hour (67°) |
| | 2 wt % APTES: Sonicated, reacted at 60° C. | |
| | 1 wt % FLUOROLINK ® L + 1% | |
| | diisopropylcarbodiimide in 100% ethanol; | |
| | Sonicated and reacted at 90° C. under vacuum | |
| 101B | Same as above | IPA: 0.5 hour (67°) |
| 101C | Same as above | IPA: 0.5 hour (69°) |
| | | WINDEX ® (commercial |
| | | ready to use grade) 0.33 hour |
| | | (69°) |
| | | WINDEX ® 2 hour (66°) |
| | | WINDEX ® 7 hour (59°) |
| 101D | Same as above | IPA: 0.5 hour (66°) |
| | | WINDEX ® 2 hour (66°) |
| | | WINDEX ® 7 hour (59°) |
| 102A | Substrate: Glass slide, regular cleaning | IPA: 0.5 hour (69°) |
| | procedure. | WINDEX ® 0.33 hour (68°) |
| | 2 wt % APTES: Sonicated, reacted at 60° C. | |
| | 1 wt % FLUOROLINK ® L + 1% | |
| | diisopropylcarbodiimide in 100% ethanol; | |
| | Sonicated and reacted at 105° C. under vacuum | |
| 102B | Same as above | IPA: 0.5 hour (67°) |
| | | WINDEX ® 0.33 hour (68°) |
| | | WINDEX ® 2 hour (66°) |
| | | WINDEX ® 4 hour (55°) |
| 103A | Substrate: Glass slide, regular cleaning | IPA: 0.5 hour (70°) |
| | procedure. | WINDEX ® 0.33 hour (69°) |
| | 2 wt % APTES: Sonicated, reacted at 60° C. | |
| | 1 wt % FLUOROLINK ® L in 100% ethanol; | |
| | Sonicated and reacted at 105° C. under vacuum | |
| 103B | Same as above | IPA: 0.5 hour (70°) |
| | | WINDEX ® 0.33 hour (70°) |
| | | WINDEX ® 4 hour (64°) |
| 104A | Substrate: Glass slide, regular cleaning | IPA: 0.5 hour (64°) |
| | procedure. | WINDEX ® 0.33 hour (67°) |
| | 2 wt % APTES: Sonicated, reacted at 60° C. | |
| | 1 wt % FLUOROLINK ® L + 1 wt % | |
| | diisopropylcarbodiimide in 100% ethanol; | |
| | Sonicated and reacted at 80° C. under vacuum | |
| 104B | Same as above | IPA: 0.5 hour (64°) |
| | | WINDEX ® 0.33 hour (65°) |
| 105A | Substrate: Glass slide, regular cleaning | IPA: 0.5 hour (72°) |
| | procedure. | WINDEX ® 0.33 hour (69°) |
| | 2 wt % APTES: Sonicated, reacted at 60° C. | |
| | 1 wt % FLUOROLINK ® L in 100% ethanol; | |
| | Sonicated and reacted at 80° C. under vacuum | |
| 105B | Same as above | IPA: 0.5 hour (67°) |
| | | WINDEX ® 0.33 hour (67°) |
| 105C | Same as above | Wipe cleaned (66°) |
| | | Soaked in Ethanol for 2 hours |
| | | and polished with cloth (66°) |
| 105D | Same as above | Wipe cleaned (64°) |
| 106A | Substrate: Glass slide, regular cleaning | IPA: 0.5 hour (67°) |
| | procedure. | |
| | 2 wt % APTES: Sonicated, reacted at 60° C. | |
| | 1 wt % FLUOROLINK ® L + 1 wt % | |
| | diisopropylcarbodiimide in 100% ethanol; | |
| | Sonicated and reacted at 70° C. under vacuum | |
| 106B | Same as above | IPA: 0.5 hour (68°) |
| 107 | Substrate: Glass slide, regular cleaning | IPA: 0.5 hour (68°) |
| | procedure. | |
| | 2 wt % APTES: Sonicated, reacted at 60° C. | |
| | 1 wt % FLUOROLINK ® L in 100% ethanol; | |
| | Sonicated and reacted at 70° C. under vacuum | |
| 108A | Substrate: Glass slide, regular cleaning | Wipe cleaned (61°) |
| | procedure. | Soaked in Ethanol for 2 hours |
| | 2 wt % APTES: Sonicated, reacted at 60° C. | and polished (32°) |
| | 1 wt % FLUOROLINK ® L in 100% ethanol; | Sonicated in IPA for 1 hour |
| | Sonicated and reacted at RT in ambient air. | |
| 108B | Same as above | Wipe cleaned (61°) |

### Example 11

### Durability of Coatings

The general procedure described in Example 7 was used to generate the samples described and reported in Table 7. The table summarizes changes in the procedures and shows the effects of these changes on the durability of the functional coating.

TABLE 11
The effects of process changes on the oleophobicity of smudge resistance
coatings and their retention after immersion in cleaning solutions.

| | Step 1: | Step 2: | Contact Angle of Oleic Acid |
|---|---|---|---|
| ID | 2% APTES | 1% FLUOROLINK ® L | (20 μl) after Post Treatment |
| Control | None | None | 28° |
| Slide | | | |
| 105C | Sonicated; | Sonicated. | Wipe cleaned (66°) |
| | Dipping temp 35° C.; | Dipping temp. 50° C. | Sonicated in WINDEX ® 5 hours |
| | Curing temp 60° C. | Heatd at 80° C. | (55°) |
| 102-2A | Sonicated; | Not sonicated; | Wipe cleaned to remove excess |
| | Dipping temp 35° C.; | Dipping temp 50° C.; | (66°) |
| | Curing temp 60° C. | Curing temp 80° C. | Sonicated in IPA for 1 hour |
| | | | (66°) |
| | | | Sonicated in WINDEX ® for 5 |
| | | | hours (60°) |
| 102-1 | Sonicated; | Not sonicated; | Wipe cleaned to remove excess |
| | Dipping temp 35° C.; | Dipping temp 50° C.; | (63°) |
| | Curing temp 60° C. | Curing temp RT. | Sonicated in IPA for 1 hour (30°) |
| 102-3 | Not sonicated; | Sonicated; | Wipe cleaned to remove excess |
| | Dipping temp 35° C.; | Dipping temp 45° C.; | (64°) |
| | Curing temp RT. | Curing temp 80° C. | Sonicated in IPA for 2 hours |
| | | | (63°) |
| | | | Sonicated in WINDEX ® for 5 |
| | | | hours (62°) |
| | | | Wipe test, 1000 pass (61°) |
| | | | Wipe test, 2000 pass (60°) |
| | | | Wipe test, 5000 pass (57°) |
| | | | Wipe test, 7000 pass (52°) |
| 102-4 | Not sonicated; | Sonicated; | Wipe cleaned to remove excess |
| | Dipping temp 35° C.; | Dipping temp 45° C.; | (64°) |
| | Curing temp 60° C. | Curing temp 80° C. | Sonicated in IPA for 1 hour (57°) |
| | | | Sonicated in WINDEX ® for 5 |
| | | | hours (53°) |
| 102-5 | Not sonicated; | Not sonicated; | Wipe cleaned to remove excess |
| | Dipping temp 35° C.; | Dipping temp 45° C.; | (54°) |
| | Curing temp RT. | Curing temp 80° C. | Sonicated in IPA for 1 hour (49°) |
| | | | Sonicated in WINDEX ® for 5 |
| | | | hours (47°) |
| 102-6B | Not sonicated; | Not sonicated; | Wipe cleaned to remove excess |
| | Dipping temp 35° C.; | Dipping temp 45° C.; | (41°) |
| | Curing temp 60° C. | Curing temp 80° C. | Sonicated in WINDEX ® for 1 |
| | | | hour (55°) |
| | | | Sonicated in WINDEX ® for 5 |
| | | | hours (59°) |
| 102-7 | Not sonicated; | Sonicated; | Wipe cleaned to remove excess |
| | Dipping temp 35° C.; | Dipping temp 45° C.; | (41°) |
| | Curing temp RT. | Curing temp RT. | Sonicated in WINDEX ® for 5 |
| | | | hours (58°) |
| 102-8 | Not sonicated; | Sonicated; | Wipe cleaned to remove excess |
| | Dipping temp 35° C.; | Dipping temp 45° C.; | (57°) |
| | Curing temp 60° C. | Curing temp RT. | Sonicated in IPA for 2 hours |
| | | | (53°) |
| 102-9 | Not sonicated; | Not sonicated; | Wipe cleaned to remove excess |
| | Dipping temp 35° C.; | Dipping temp 45° C.; | (40°) |
| | Curing temp RT. | Curing temp RT. | Sonicated in IPA for 1 hour (35°) |
| 102-10 | Not sonicated; | Not sonicated; | Wipe cleaned to remove excess |
| | Dipping temp 35° C.; | Dipping temp 45° C.; | (52°) |
| | Curing temp 60° C. | Curing temp RT. | Sonicated in IPA for 1 hour (50°) |

### Example 12

### Smudge Resistance Treatment to PET Flexible Film

PET film was cut to about 3×10 cm strips and washed with 95% Ethanol and air dried. The film was treated by corona discharge tool for 2 min on each side of the film. The strips were soaked in 2 wt % APTES in 95% Ethanol for 2 min while sonicating. The strips were washed by sonicating in 95% Ethanol for 1 min followed by curing at 60° C. in air for 10 min. A second step of dipping in 1 wt % FLUOROLINK® C solution in 100% Ethanol was performed for 2 min while sonicating. Excess of the fluoro reagent was washed by sonicating in 95% Ethanol for 1 min. The procedure was completed by curing at 120 to 140° C. for 1 hour under vacuum. Residual fluoro reagent was removed by sonicating in 95% Ethanol for 30 min and followed by sonicating in Isopropanol for 30-60 min. In-spite of the prolonged sonication the film continued to demonstrate high contact angles for oleic acid. Contact angles of 65° to 68° for oleic acids and 101° to 107° for water droplets were observed after 2 hours of sonication in acetone, isopropanol and hexane on samples cured at 120 and 140° C.

### Example 13

### Smudge-Resistant Coatings on Transparent Polycarbonate Substrate

The following process was used to deposit well-adhered smudge-resistant coatings on 1″×3″×0.12″ transparent polycarbonate specimens (MAKROLON® AR, abrasion-resistant silica treatment deposited on one side).

Cleaning: The protective film was removed from both sides of the substrate and it was wash with 95% ethanol and then dried at room temperature.

Corona treatment: Corona discharge treatment was applied at each side of substrate for 5 minutes

Step 1 coating: the polycarbonate specimens were dipped into a solution of 85 g of 2 wt % APTES (aminopropyltriethoxysilane) in 95% ethanol, placed in a staining jar, and kept in the solution for 2 min. The treated specimens were washed with 95% ethanol by sonicating for 1 min and then dried and cured at 60° C. for 10 min in air.

Step 2 coating: A solution of 55 g of 1 wt % FLUOROLINK® L in 100% ethanol was placed in a 60 ml glass bottle with cap and stiffing and heated to 50° C. while stirring in a water bath. The substrates treated in Step 1 were immersed into the FLUOROLINK® L solution and kept at 50° C. for 3 min. The treated specimens were then taken out of the solution and heated at 90° C. under vacuum for 60 min. The coated substrates were washed with isopropanol and further sonicated in the same solvent for 30 min to assess the coating durability. Any excess of FLUOROLINK® L was wiped with Kimwipe paper.

The treated specimens demonstrated both high repellency of oil expressed by a contact angle of 69° for oleic acid. After 5000 wipes with a microfiber cloth the measured contact angle was 67°.

What is claimed is:

1. A method for forming a functional layer on a substrate, the method comprising:
(i) a first step of forming a first layer of a coupling compound on a surface of the substrate by contacting and chemically bonding the coupling compound to the substrate, wherein: the coupling compound comprises a first reactive group and a second reactive group, provided that the first reactive group and the second reactive group may be the same or different; the surface of the substrate comprises surface-exposed reactive groups; the first reactive group of the coupling compound chemically bonds with a surface exposed reactive group; and the second reactive group of the coupling compound remains unreacted with the surface; and
(ii) a second step of forming a functional layer of a functional layer compound by contacting and chemically bonding the functional layer compound to the coupling compound, wherein: the functional layer compound comprises a reactive group and a functional group; the second reactive group of the coupling compound chemically bonds with the reactive group of the functional layer compound; and the second step is optionally carried out in the presence of a catalyst.

2. The method of claim 1, wherein the functional layer is a monolayer of the functional layer compound and is chemically bonded to the substrate.

3. The method of claim 2, wherein the method further comprises exposing the substrate to an elevated temperature for a period of time, wherein the exposure is carried out after the first step, after the second step, or after both first and second steps.

4. The method of claim 1, wherein the method further comprises optionally removing any non-bonded coupling compound from the surface after the first step, and optionally removing any non-bonded functional layer compound from the surface after the second step.

5. The method of claim 1, wherein prior to the first step the substrate is precoated or pretreated to activate the surface of the substrate for chemically bonding with the coupling compound.

6. The method of claim 1, wherein the surface-exposed reactive groups are selected from metal oxides, metal hydroxides, silicon-hydroxides, silicates, phosphates, phosphonates, sulfur oxides, amines, imines, carbonates, urethanes, anhydrides, oxiranes, olefins, vinyl compounds, esters, functionalized aromatics, hydroxyls, thiols, disulfides, carboxylic acids, hydrosilanes, and functionalized organosiloxanes.

7. The method of claim 1, wherein the first and second reactive groups of the coupling compound are independently selected from protected or unprotected alkoxysilane, hydroxysilane, halosilane, hydrosilane, silazanyl, organosiloxane, phosphonate, phosphine, sulfur oxide, thiol, disulfide, sulphonate, amine, imine, amide, urethane, ureate, cyanurate, carboxylic acid, anhydride, ester, epoxy, carbonate, olefin, anhydride, vinyl, acrylate, metacrylate, cyanate, isocyanate, thiocyanate, isothiocyanate, aromatic, acetylacetonate, alcohol, and ether, aldehyde, hydroxysilane, carboxysilane, enoxysilane, organosilane, aminosilane, thiosilane, epoxysilane, silanecarbylcarboxyl, vinylsilane, and alpha olefin silane, provided that: (1) when the first reactive group of the coupling compound is a protected group, the method further comprises deprotecting the first reactive group prior to or during the first step with a protecting group removal agent; and (2) when the second reactive group of the coupling compound is a protected group, the method further comprises deprotecting the second reactive group prior to or during the second step with a protecting group removal agent or with the functional layer compound.

8. The method of claim 1, wherein the first reactive group and the second reactive group are different, and wherein the second reactive group of the coupling compound is relatively unreactive toward the surface exposed reactive groups compared with the first reactive group of the coupling compound.

9. The method of claim 8, wherein the coupling compound optionally further comprises one or more additional reactive groups that are the same as the first reactive group, and wherein the coupling compound optionally further comprises one or more additional reactive groups that are the same as the second reactive group.

10. The method of claim 1, wherein the first and second reactive groups of the coupling compound are the same, and wherein the coupling compound optionally further comprises one or more additional reactive groups that are the same as the first reactive group.

11. The method of claim 1, wherein the functional layer compound further optionally comprises one or more additional reactive groups, and wherein the reactive group or groups on the functional layer compound are selected from protected or unprotected amine, imine, carbonate, urethane, anhydride, epoxy, vinyl, acrylate, metacrylate, cyanate, isocyanate, thiocyanate, isothiocyanate, hydroxyl, aldehyde, thiol, disulphide, carboxylic acid, ester, halosilane, hydrosilane, hydroxysilane, carboxysilane, enoxysilane, epoxysilane, alkoxysilane, vinylsilane, aminosilane, halosilane, hydrosilane, silazanyl, organosiloxane, phosphonate, phosphine, sulfur oxide, thiol, disulfide, sulphonate, amide, ureate, cyanurate, carboxylic acid, anhydride, olefin, aromatic, acetylacetonate, alcohol, and ether, hydroxysilane, organosilane, aminosiloxane, thiosilane, silanecarbylcarboxyl, and alpha olefin silane.

12. The method of claim 1, wherein the functional group of the functional layer compound is relatively unreactive toward the second reactive group of the coupling compound compared with the reactive group of the functional layer compound.

13. The method of claim 12, wherein the functional group of the functional layer compound is selected from substituted or unsubstituted hydrocarbon, halocarbon, ether, haloether, ester, carboxylic acid, sulphonic acid, phosphonic acid, amine, amide, carbinol, aromatic, organosilane, fluorinated organosilane, and organosiloxane and fluorinated organosilane.

14. The method of claim 13, wherein the functional layer compound comprises a polymeric backbone comprising multiple monomeric units, each of which contains the functional group.

15. A functionalized substrate surface prepared according to the method of claim 1.

16. The functionalized substrate surface of claim 15, wherein, relative to the unfunctionalized substrate surface, the functionalized substrate surface is smudge resistant, facilitates minimization of deposition of foreign material on the surface, and facilitates rapid removal of foreign material deposited on the surface.

17. A method for preparing a functionally coated substrate, the method comprising:
(i) forming a chemical bond between a reactive group attached to a substrate and a first reactive group on a coupling compound such that the coupling compound is chemically bounded to the surface, wherein the coupling compound further comprises a second reactive group; and
(ii) forming a chemical bond between the second reactive group on the coupling compound and a reactive group on a functional layer compound.

18. The method of claim 17, wherein the functional layer compound provides a chemically bonded functional layer on the surface having a property selected from oleophobic, oleophilic, hydrophobic, hydrophilic, electrostatic, sorbing, electroresponsive, charge responsive, catalytic, bioinert, and bioactive, smudge resistant, easy clean, or combinations thereof.

19. The method of claim 17, wherein the second reactive group of the coupling compound is non-reactive with the reactive group attached to the substrate, or wherein the second reactive group of the coupling compound is a protected reactive group and the method further comprises contacting the protected reactive group with a protecting group removal agent.

20. The method of claim 17, further comprising exposing the substrate to additional reaction time at elevated temperature, wherein the exposing is carried out after the coupling compound is initially interacted with the substrate or after the functional layer compound is interacted with the coupling compound.

21. The method of claim 17, wherein the functional layer compound is fluorinated, silylated, hydroxylated, aminated, or any combination thereof.

22. A functionalized coated substrate surface prepared according to claim 17.
